(19) United States
(12) Patent Application Publication
(10) Pub. No.: US 2012/0014433 A1
(43) Pub. Date: Jan. 19, 2012

(54) ENTROPY CODING OF BINS ACROSS BIN GROUPS USING VARIABLE LENGTH CODEWORDS

(75) Inventors: Marta Karczewicz, San Diego, CA (US); Rajan L. Joshi, San Diego, CA (US)

(73) Assignee: QUALCOMM Incorporated, San Diego, CA (US)

(21) Appl. No.: 13/182,247

(22) Filed: Jul. 13, 2011

Related U.S. Application Data
(60) Provisional application No. 61/503,508, filed on Jun. 30, 2011.
(60) Provisional application No. 61/364,763, filed on Jul. 15, 2010.

(51) Int. Cl. H04N 7/12

(52) U.S. Cl. 375/240.02; 375/E07.126; 375/E07.026

(57) ABSTRACT

This disclosure describes techniques for entropy coding bins representing video data symbols with reduced bottlenecks in the entropy coding process. The techniques of this disclosure enable an entropy coding device to perform entropy coding of bins grouped into bin subsets from across different bin groups, e.g., context groups or probability groups, using variable length codewords. In one example, the bins may be assigned to context groups with no context dependencies between the context groups. In another example, the bins may be assigned to probability groups associated with different intervals of probability states. The bins may be grouped into the bin subsets according to determined formations of the bin subsets. In this way, the entropy coding device may reduce an amount of bin and codeword buffering by efficiently forming the bin subsets and designing variable length codewords for each of the bin subsets.

This application claims the benefit of U.S. Provisional Application No. 61/364,763, filed Jul. 15, 2010, and U.S. Provisional Application No. 61/503,508, filed Jun. 30, 2011, each of which is hereby incorporated by reference in its respective entirety.

### TECHNICAL FIELD

This disclosure relates to video coding and, more particularly, entropy coding for video coding.

### BACKGROUND

Digital video capabilities can be incorporated into a wide range of devices, including digital televisions, digital direct broadcast systems, wireless broadcast systems, personal digital assistants (PDAs), laptop or desktop computers, digital cameras, digital recording devices, digital media players, video gaming devices, video game consoles, cellular or satellite radio telephones, video teleconferencing devices, and the like. Digital video devices implement video compression techniques, such as those described in the standards defined by MPEG-2, MPEG-4, ITU-T H.263, ITU-T H.264/MPEG-4, Part 10, Advanced Video Coding (AVC), or the emerging High Efficiency Video Coding (HEVC) standard, and extensions of such standards.

Video compression techniques perform spatial prediction and/or temporal prediction to reduce or remove redundancy inherent in video sequences. For block-based video coding, a video frame or slice may be partitioned into video blocks or coding units (CUs). CUs may be further partitioned into one or more prediction units (PUs) to determine predictive video data for the CU. The video compression techniques may also partition the CUs into one or more transform units (TUs) of residual video block data, which represents the difference between the video block to be coded and the predictive video data. Linear transforms, such as a two-dimensional discrete cosine transform (DCT), may be applied to a TU to transform the residual video block data from the pixel domain to the frequency domain to achieve further compression.

Following the transforms, transform coefficients within the TU may be further compressed via quantization. Following quantization, an entropy coding unit may apply a zig-zag scan or another scan order associated with a size of the TU to scan the coefficients to produce a serialized vector that can be entropy encoded. The entropy coding unit then entropy codes the serialized vector of coefficients and syntax elements for the CU. For example, the entropy coding unit may perform context adaptive variable length coding (CAVLC), context adaptive binary arithmetic coding (CABAC), or another entropy coding technique. The entropy coding unit may select contexts for the coefficients and syntax elements to determine probability estimates for values of the coefficients and syntax elements according to a context model. In the case of CABAC, the coefficients and syntax elements may be binarized and arithmetically encoded based on the probability estimates. In the case of CAVLC, the coefficients and syntax elements may be encoded using variable length codewords based on the probability estimates.

### SUMMARY

In general, this disclosure describes techniques for entropy coding binary bits, i.e., bins, representing video data symbols with reduced bottlenecks in the entropy coding process. Conventional entropy coding techniques may cause bottlenecks in the entropy coding process. For example, context adaptive binary arithmetic coding (CABAC) provides low throughput due to bin level serial processing. Parallel variable-to-variable length (V2V) entropy coding provides higher throughput than CABAC, but requires large amounts of buffering while waiting to form valid V2V codewords for different bin groups. The techniques of this disclosure enable an entropy coding device to perform entropy coding of bins grouped into bin subsets from across different bin groups, e.g., context groups or probability groups, using variable length codewords. The bins may be grouped into the bin subsets according to determined formations of the bin subsets that define a number of bins from one or more of the bin groups included in each of the bin subsets. In this way, the techniques enable the entropy coding device to achieve high throughput while reducing an amount of bin and codeword buffering by efficiently forming the bin subsets and designing variable length codewords for each of the bin subsets.

In one example, the techniques includes selecting a context group to assign a given bin based on a context of the bin, and selecting a bin subset into which the bin is grouped with bins from across the context groups. In this example, the bins in the sequence of bins may be partitioned into different context groups such that there are no context dependencies between bins in each of the context groups. Each of the context groups may, for example, include bins that represent a certain type of syntax element because contexts for one type of syntax element have no bearing on contexts for another type of syntax element. Bins from across one or more of the context groups are then grouped into bin subsets based on determined formations of the subsets, and variable length codewords are used to code the bins in each of the bin subsets.

In another example, the techniques includes selecting a probability group to assign a given bin based on a probability state associated with a context of the bin, and selecting a bin subset into which the bin is grouped with bins from across the probability groups. In this example, the bins in the sequence of bins may be partitioned into different probability groups such that bins in each of the probability groups have probability states within an interval associated with the probability group. The intervals associated with the probability groups may, for example, comprise discrete ranges of probability states determined from a range of all possible probability states. Bins from across one or more of the probability groups are then grouped into bin subsets based on determined formations of the subsets, and variable length codewords are used to code the bins in each of the bin subsets.

In one example, the disclosure describes a method for coding video data comprising selecting a context for each bin in a sequence of bins representing video data symbols, selecting one of a plurality of context groups for each of the bins based on the context of the bin, wherein bins in one of the context groups do not have context dependencies with bins in another of the context groups, selecting one of one or more bin subsets for each of the bins based on determined formations of the bin subsets, wherein each of the bin subsets includes bins from across one or more of the context groups, and entropy coding the bins in each of the bin subsets using variable length codewords.

In another example, the disclosure describes a video coding device comprising a memory that stores video data symbols, and a processor configured to select a context for each bin in a sequence of bins representing video data symbols, select one of a plurality of context groups for each of the bins based on the context of the bin, wherein bins in one of the context groups do not have context dependencies with bins in another of the context groups, select one of one or more bin subsets for each of the bins based on determined formations of the bin subsets, wherein each of the bin subsets includes bins from across one or more of the context groups, and entropy code the bins in each of the bin subsets using variable length codewords.

In another example, the disclosure describes a video coding device comprising means for selecting a context for each bin in a sequence of bins representing video data symbols, means for selecting one of a plurality of context groups for each of the bins based on the context of the bin, wherein bins in one of the context groups do not have context dependencies with bins in another of the context groups, means for selecting one of one or more bin subsets for each of the bins based on determined formations of the bin subsets, wherein each of the bin subsets includes bins from across one or more of the context groups, and means for entropy coding the bins in each of the bin subsets using variable length codewords.

In a further example, the disclosure describes a computer-readable medium comprising instructions for coding video data that, when executed, cause a processor to select a context for each bin in a sequence of bins representing video data symbols, select one of a plurality of context groups for each of the bins based on the context of the bin, wherein bins in one of the context groups do not have context dependencies with bins in another of the context groups, select one of one or more bin subsets for each of the bins based on determined formations of the bin subsets, wherein each of the bin subsets includes bins from across one or more of the context groups, and entropy code the bins in each of the bin subsets using variable length codewords.

In another example, the disclosure describes a method for coding video data comprising determining a probability state associated with a context for each bin in a sequence of bins representing video data symbols, selecting one of a plurality of probability groups for each of the bins based on the probability state of the bin, wherein bins in each of the probability groups have probability states within an interval associated with the probability group, selecting one of one or more bin subsets for each of the bins based on determined formations of the bin subsets, wherein each of the bin subsets includes bins from across one or more of the probability groups, and entropy coding the bins in each of the bin subsets using variable length codewords.

In a further example, the disclosure describes a video coding device comprising a memory that stores video data symbols, and a processor configured to determine a probability state associated with a context for each bin in a sequence of bins representing video data symbols, select one of a plurality of probability groups for each of the bins based on the probability state of the bin, wherein bins in each of the probability groups have probability states within an interval associated with the probability group, select one of one or more bin subsets for each of the bins based on determined formations of the bin subsets, wherein each of the bin subsets includes bins from across one or more of the probability groups, and entropy code the bins in each of the bin subsets using variable length codewords.

In another example, the disclosure describes a video coding device comprising means for determining a probability state associated with a context for each bin in a sequence of bins representing video data symbols, means for selecting one of a plurality of probability groups for each of the bins based on the probability state of the bin, wherein bins in each of the probability groups have probability states within an interval associated with the probability group, means for selecting one of one or more bin subsets for each of the bins based on determined formations of the bin subsets, wherein each of the bin subsets includes bins from across one or more of the probability groups, and means for entropy coding the bins in each of the bin subsets using variable length codewords.

In a further example, the disclosure describes a computer-readable medium comprising instructions for coding video data that, when executed, cause a processor to determine a probability state associated with a context for each bin in a sequence of bins representing video data symbols, select one of a plurality of probability groups for each of the bins based on the probability state of the bin, wherein bins in each of the probability groups have probability states within an interval associated with the probability group, select one of one or more bin subsets for each of the bins based on determined formations of the bin subsets, wherein each of the bin subsets includes bins from across one or more of the probability groups, and entropy code the bins in each of the bin subsets using variable length codewords.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example video encoding and decoding system that may utilize techniques for performing entropy coding of bins grouped into bin subsets from across different bin groups, e.g., context groups or probability groups, using variable length codewords.

FIG. 2 is a block diagram illustrating an example video encoder that may implement techniques for entropy encoding bins across bin groups using variable length codewords.

FIG. 3A is a conceptual diagram illustrating exemplary determined formations of bin subsets from across different context groups.

FIG. 3B is a conceptual diagram illustrating exemplary determined formations of bin subsets from across different probability groups

FIG. 4 is a block diagram illustrating an example video decoder that may implement techniques for entropy decoding bins across bin groups using variable length codewords.

FIGS. 5A and 5B are block diagrams respectively illustrating an example entropy encoding unit and an example entropy decoding unit configured to entropy code bins from across context groups.

FIGS. 6A and 6B are block diagrams respectively illustrating an example entropy encoding unit and an example entropy decoding unit configured to entropy code bins from across probability groups.

FIG. 7 is a flowchart illustrating an example operation of entropy encoding and decoding bins grouped into bin subsets from across context groups using variable length codewords.

FIG. 8 is a flowchart illustrating an example operation of entropy encoding and decoding bins grouped into bin subsets from across probability groups using variable length codewords.

### DETAILED DESCRIPTION

This disclosure describes techniques for entropy coding binary bits, i.e., bins, representing video data symbols with reduced bottlenecks in the entropy coding process. Conventional entropy coding techniques may cause bottlenecks in the entropy coding process. For example, context adaptive binary arithmetic coding (CABAC) provides low throughput due to bin level serial processing. Parallel variable-to-variable length (V2V) entropy coding provides higher throughput than CABAC, but requires large amounts of buffering while waiting to form valid V2V codewords for different bin groups. The techniques of this disclosure enable an entropy coding device to perform entropy coding of bins grouped into bin subsets from across different bin groups, e.g., context groups or probability groups, using variable length codewords. The bins may be grouped into the bin subsets according to determined formations of the bin subsets that define a number of bins from one or more bin groups included in each of the bin subsets. In this way, the techniques enable the entropy coding device to achieve high throughput while reducing an amount of bin and codeword buffering by efficiently forming the bin subsets and designing variable length codewords for each of the bin subsets.

In one example, the bins in the sequence of bins may be partitioned into different context groups such that there are no context dependencies between bins in each of the context groups. The context groups may be formed such that the bin values from one context group do not affect the contexts of the bins in another context group. As an example, bins with contexts used for coding motion vector differences may be placed in one context group whereas bins with contexts corresponding to transform coefficient significant map coding and level coding may be placed in another context group.

In another example, the bins in the sequence of bins may be partitioned into different probability groups such that bins in each of the probability groups have probability states within an interval associated with the probability group. The intervals associated with the probability groups may, for example, comprise discrete ranges of probability states determined from a range of all possible probability states. In either case, bins from across one or more of the bin groups are grouped into the bin subsets and entropy coded using variable length codewords.

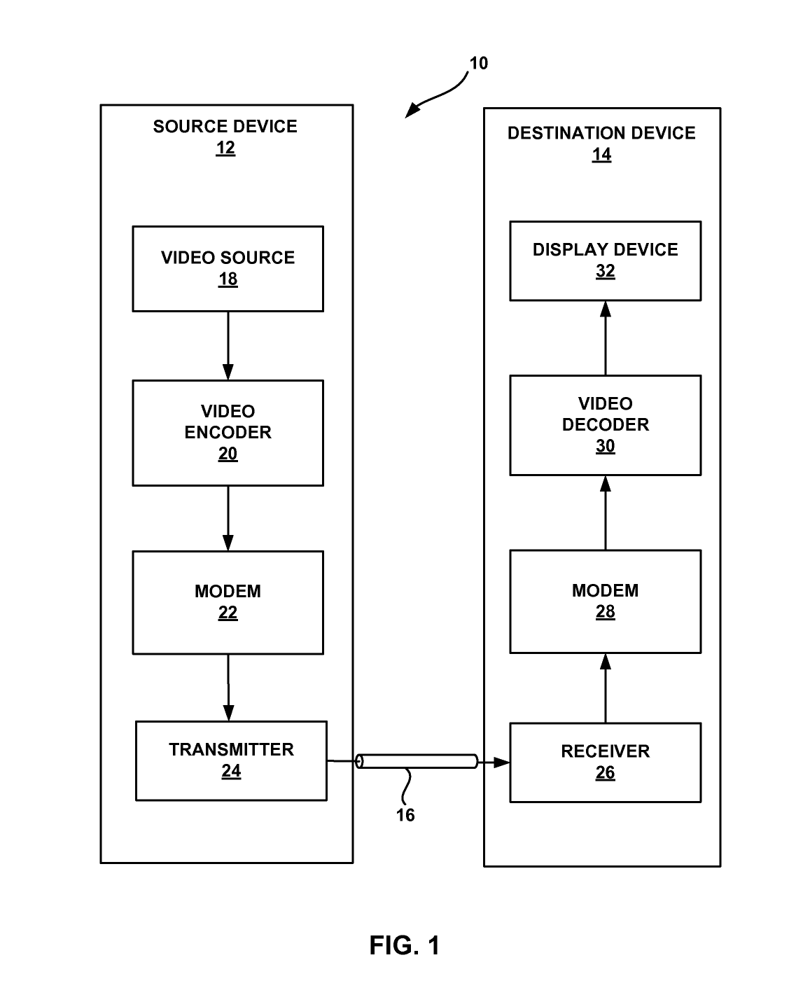

FIG. 1 is a block diagram illustrating an example video encoding and decoding system that may utilize techniques for performing entropy coding of bins grouped into bin subsets from across different bin groups, e.g., context groups or probability groups, using variable length codewords. As shown in FIG. 1, system 10 includes a source device 12 that transmits encoded video to a destination device 14 via a communication channel 16. Source device 12 and destination device 14 may not necessarily participate in real-time active communication with one another. In some cases, source device 12 may store the encoded video data for a period of time before retrieving the encoded video data from storage for transmission to destination device 14. Source device 12 and destination device 14 may comprise any of a wide range of devices. In some cases, source device 12 and destination device 14 may comprise wireless communication devices that can communicate video information over a communication channel 16, in which case communication channel 16 is wireless.

The techniques of this disclosure, however, which concern entropy coding of bins from across bin groups using variable length codewords. For example, these techniques may apply to over-the-air television broadcasts, cable television transmissions, satellite television transmissions, Internet video transmissions, encoded digital video that is encoded onto a storage medium, or other scenarios. Accordingly, communication channel 16 may comprise any combination of wireless or wired media suitable for transmission of encoded video data, and devices 12, 14 may comprise any of a variety of wired or wireless media devices such as mobile telephones, smartphones, digital media players, set-top boxes, televisions, displays, desktop computers, portable computers, tablet computers, gaming consoles, portable gaming devices, or the like.

In the example of FIG. 1, source device 12 includes a video source 18, video encoder 20, a modulator/demodulator (modem) 22 and a transmitter 24. Destination device 14 includes a receiver 26, a modem 28, a video decoder 30, and a display device 32. In other examples, a source device and a destination device may include other components or arrangements. For example, source device 12 may receive video data from an external video source 18, such as an external camera, a video storage archive, a computer graphics source, or the like. Likewise, destination device 14 may interface with an external display device, rather than including an integrated display device.

The illustrated system 10 of FIG. 1 is merely one example. In other examples, any digital video encoding and/or decoding device may perform the disclosed techniques for entropy coding of bins from across bin groups using variable length codewords. The techniques may also be performed by a video encoder/decoder, typically referred to as a “CODEC.” Moreover, the techniques of this disclosure may also be performed by a video preprocessor. Source device 12 and destination device 14 are merely examples of such coding devices in which source device 12 generates coded video data for transmission to destination device 14. In some examples, devices 12, 14 may operate in a substantially symmetrical manner such that each of devices 12, 14 include video encoding and decoding components. Hence, system 10 may support one-way or two-way video transmission between video devices 12, 14, e.g., for video streaming, video playback, video broadcasting, or video telephony.

Video source 18 of source device 12 may include a video capture device, such as a video camera, a video archive containing previously captured video, and/or a video feed from a video content provider. As a further alternative, video source 18 may generate computer graphics-based data as the source video, or a combination of live video, archived video, and computer-generated video. In some cases, if video source 18 is a video camera, source device 12 and destination device 14 may form so-called camera phones or video phones. As mentioned above, however, the techniques described in this disclosure may be applicable to video coding in general, and may be applied to wireless and/or wired applications. In each case, the captured, pre-captured, or computer-generated video may be encoded by video encoder 20. The encoded video information may then be modulated by modem 22 according to a communication standard, and transmitted to destination device 14 via transmitter 24. Modem 22 may include various mixers, filters, amplifiers or other components designed for signal modulation. Transmitter 24 may include circuits designed for transmitting data, including amplifiers, filters, and one or more antennas.

In accordance with this disclosure, video encoder 20 of source device 12 may be configured to apply the techniques for entropy encoding of bins grouped into bin subsets from across bin groups, e.g., context groups or probability groups, using variable length codewords. Conventional entropy coding techniques may cause bottlenecks in the entropy coding process. For example, context adaptive binary arithmetic coding (CABAC) provides low throughput due to bin level serial processing. Parallel variable-to-variable length (V2V) entropy coding provides higher throughput than CABAC, but requires large amounts of buffering while waiting to form valid V2V codewords for different bin groups. The disclosed techniques enable video encoder 20 to achieve high throughput while reducing an amount of bin and codeword buffering by efficiently forming the bin subsets and designing variable length codewords for each of the bin subsets.

Video encoder 20 may first binarize one or more video data symbols that are not already binary valued into binary bits, i.e., bins. Video encoder 20 may skip the binarization step for video data symbols that are already binary valued. Video encoder 20 may then select contexts for each of the bins in a sequence of bins. Video encoder 20 may then perform the entropy encoding techniques described herein. As one example, video encoder 20 may assign each of the bins in the sequence of bins to one of a plurality of context groups based on the context of the bin, and group bins from across one or more of the context groups into bin subsets based on determined formations of the bin subsets. In this example, the different context groups may be defined such that there are no context dependencies between bins in each of the context groups. The context groups may be formed such that the bin values from one context group do not affect the contexts of bins in another context group. As an example, bins with contexts used for coding motion vector differences may be placed in one context group whereas bins with contexts corresponding to transform coefficient significant map coding and level coding may be placed in another context group. The different bin subsets may be defined according to the determined formations of the bin subsets that define one bin from one or more context groups included in each of the bin subsets. Video encoder 20 then entropy encodes the bins in each of the bin subsets using variable length codewords designed for the bin subset.

As another example, video encoder 20 may assign each of the bins in the sequence of bins to one of a plurality of probability groups based on a probability state associated with the context of the bin, and group bins from across one or more of the probability groups into bin subsets based on determined formations of the bin subsets. In this way, video encoder 20 may only need to keep track of a probability state of each bin, and not the actual context assigned to the bin. In this example, the different probability groups may be defined according to different intervals such that bins in each of the probability groups have probability states within the interval associated with the probability group. The intervals associated with the probability groups may, for example, be determined by dividing a range of all possible probability states into discrete ranges of probability states. The different bin subsets may be defined according to the determined formations of the bin subsets that define a number of bins from one or more probability groups included in each of the bin subsets. Video encoder 20 then entropy encodes the bins in each of the bin subsets using variable length codewords designed for the bin subset.

Receiver 26 of destination device 14 receives information over channel 16, and modem 28 demodulates the information. The information communicated over channel 16 may include syntax information defined by video encoder 20, which is also used by video decoder 30, that includes syntax elements that describe characteristics and/or processing of coding units (CUs), prediction units (PUs), transform units (TUs) or other units of coded video, e.g., video slices, video frames, and video sequences or groups of pictures (GOPs). Display device 32 displays the decoded video data to a user, and may comprise any of a variety of display devices such as a cathode ray tube (CRT), a liquid crystal display (LCD), a plasma display, an organic light emitting diode (OLED) display, or another type of display device.

In accordance with this disclosure, video decoder 30 of destination device 14 may be configured to apply the techniques for entropy decoding of bins grouped into bin subsets from across bin groups, e.g., context groups or probability groups, using variable length codewords. Video decoder 30 may first select context for a next bin in the sequence of bins to be decoded into video data symbols.

As one example, video decoder 30 may select one of a plurality of context groups to which the next bin is assigned based on the context of the next bin, and select one of the bin subsets in which the next bin is grouped with bins from across one or more of the context groups based on determined formations of the bin subsets. In this example, the different context groups may be defined such that there are no context dependencies between bins in each of the context groups. The context groups may be formed such that the bin values from one context group do not affect the contexts of bins in another context group. As an example, bins with contexts used for coding motion vector differences may be placed in one context group whereas bins with contexts corresponding to transform coefficient significant map coding and level coding may be placed in another context group. The different bin subsets may be defined according to the determined formations of the bin subsets that define one bin from one or more of the context groups included in each of the bin subsets.

Video decoder 30 may then entropy decode the variable length codeword associated with the selected bin subset into bins, including the next bin, within the selected bin subset. Video decoder 30 may fill the decoded bin values into the selected bin subset. If any of the decoded bins represents a portion of a non-binary valued video data symbol, video decoder 30 may de-binarize one or more decoded bins into the video data symbol.

As another example, video decoder 30 may select one of a plurality of probability groups to which the next bin is assigned based on a probability state associated with the context of the next bin, and select one of the bin subsets in which the next bin is grouped with bins from across one or more of the probability groups based on determined formations of the bin subsets. In this way, video decoder 30 may only need to keep track of a probability state of each bin, and not the actual context assigned to the bin. In this example, the different probability groups may be defined according to different intervals such that bins in each of the probability groups have probability states within the interval associated with the probability group. The intervals associated with the probability groups may, for example, be determined by dividing a range of all possible probability states into discrete ranges of probability states. The different bin subsets may be defined according to the determined formations of the bin subsets that define a number of bins from one or more of the probability groups included in each of the bin subsets.

Video decoder 30 may then entropy decode the variable length codeword associated with the selected bin subset into bins, including the next bin, within the selected bin subset. Video decoder 30 may then fill the decoded bin values into the selected bin subset. If one of the decoded bins represents a portion of a non-binary valued video data symbol, video decoder 30 may de-binarize one or more decoded bins into the video data symbol.

In the example of FIG. 1, communication channel 16 may comprise any wireless or wired communication medium, such as a radio frequency (RF) spectrum or one or more physical transmission lines, or any combination of wireless and wired media. Communication channel 16 may form part of a packet-based network, such as a local area network, a wide-area network, or a global network such as the Internet. Communication channel 16 generally represents any suitable communication medium, or collection of different communication media, for transmitting video data from source device 12 to destination device 14, including any suitable combination of wired or wireless media. Communication channel 16 may include routers, switches, base stations, or any other equipment that may be useful to facilitate communication from source device 12 to destination device 14.

Video encoder 20 and video decoder 30 may operate according to a video compression standard, such as the emerging High Efficiency Video Coding (HEVC) standard or the ITU-T H.264 standard, alternatively referred to as MPEG-4, Part 10, Advanced Video Coding (AVC). The techniques of this disclosure, however, are not limited to any particular coding standard. Other examples include MPEG-2 and ITU-T H.263. Although not shown in FIG. 1, in some aspects, video encoder 20 and video decoder 30 may each be integrated with an audio encoder and decoder, and may include appropriate MUX-DEMUX units, or other hardware and software, to handle encoding of both audio and video in a common data stream or separate data streams. If applicable, MUX-DEMUX units may conform to the ITU H.223 multiplexer protocol, or other protocols such as the user datagram protocol (UDP).

The HEVC standardization efforts are based on a model of a video coding device referred to as the HEVC Test Model (HM). The HM presumes several additional capabilities of video coding devices relative to existing devices according to, e.g., ITU-T H.264/AVC. The HM refers to a block of video data as a coding unit (CU). Syntax data within a bitstream may define a largest coding unit (LCU), which is a largest coding unit in terms of the number of pixels. In general, a CU has a similar purpose to a macroblock of the H.264 standard, except that a CU does not have a size distinction. Thus, a CU may be split into sub-CUs. In general, references in this disclosure to a CU may refer to a largest coding unit of a picture or a sub-CU of an LCU. An LCU may be split into sub-CUs, and each sub-CU may be further split into sub-CUs. Syntax data for a bitstream may define a maximum number of times an LCU may be split, referred to as CU depth. Accordingly, a bitstream may also define a smallest coding unit (SCU).

A CU that is not further split (i.e., a leaf node of an LCU) may include one or more prediction units (PUs). In general, a PU represents all or a portion of the corresponding CU, and includes data for retrieving a reference sample for the PU. For example, when the PU is intra-mode encoded, the PU may include data describing an intra-prediction mode for the PU. As another example, when the PU is inter-mode encoded, the PU may include data defining a motion vector for the PU. The data defining the motion vector may describe, for example, a horizontal component of the motion vector, a vertical component of the motion vector, a resolution for the motion vector (e.g., one-half pixel precision, one-quarter pixel precision, or one-eighth pixel precision), a reference frame to which the motion vector points, and/or a reference frame list (e.g., List 0 or List 1) for the motion vector. Data for the CU defining the PU(s) may also describe, for example, partitioning of the CU into one or more PUs. Partitioning modes may differ between whether the CU is skip or direct mode encoded, intra-prediction mode encoded, or inter-prediction mode encoded.

A CU having one or more PUs may also include one or more transform units (TUs). Following prediction using a PU, a video encoder may calculate residual values for the portion of the CU corresponding to the PU. The residual values included in the TUs correspond to pixel difference values that may be transformed into transform coefficients quantized, and scanned to produce serialized transform coefficients for entropy coding. A TU is not necessarily limited to the size of a PU. Thus, TUs may be larger or smaller than corresponding PUs for the same CU. In some examples, the maximum size of a TU may be the size of the corresponding CU. This disclosure uses the term “video block” to refer to any of a CU, PU, or TU.

Video encoder 20 and video decoder 30 each may be implemented as any of a variety of suitable encoder circuitry, such as one or more microprocessors, digital signal processors (DSPs), application specific integrated circuits (ASICs), field programmable gate arrays (FPGAs), discrete logic, software, hardware, firmware or any combinations thereof. Each of video encoder 20 and video decoder 30 may be included in one or more encoders or decoders, either of which may be integrated as part of a combined encoder/decoder (CODEC) in a respective camera, computer, mobile device, subscriber device, broadcast device, set-top box, server, or the like.

A video sequence or group of pictures (GOP) typically includes a series of video frames. A GOP may include syntax data in a header of the GOP, a header of one or more frames of the GOP, or elsewhere, that describes a number of frames included in the GOP. Each frame may include frame syntax data that describes an encoding mode for the respective frame. Video encoder 20 typically operates on video blocks within individual video frames in order to encode the video data. A video block may correspond to a coding unit (CU) or a partition unit (PU) of the CU. The video blocks may have fixed or varying sizes, and may differ in size according to a specified coding standard. Each video frame may include a plurality of slices. Each slice may include a plurality of CUs, which may include one or more PUs.

As an example, the HEVC Test Model (HM) supports prediction in various CU sizes. The size of an LCU may be defined by syntax information. Assuming that the size of a particular CU is 2N×2N, the HM supports intra-prediction in sizes of 2N×2N or N×N, and inter-prediction in symmetric sizes of 2N×2N, 2N×N, N×2N, or N×N. The HM also supports asymmetric splitting for inter-prediction of 2N×nU, 2N×nD, nL×2N, and nR×2N. In asymmetric splitting, one direction of a CU is not split, while the other direction is split into 25% and 75%. The portion of the CU corresponding to the 25% split is indicated by an “n” followed by an indication of “Up”, “Down,” “Left,” or “Right.” Thus, for example, “2N×nU” refers to a 2N×2N CU that is split horizontally with a 2N×0.5N PU on top and a 2N×1.5N PU on bottom.

In this disclosure, “N×N” and “N by N” may be used interchangeably to refer to the pixel dimensions of a video block (e.g., CU, PU, or TU) in terms of vertical and horizontal dimensions, e.g., 16×16 pixels or 16 by 16 pixels. In general, a 16×16 block will have 16 pixels in a vertical direction (y=16) and 16 pixels in a horizontal direction (x=16). Likewise, an N×N block generally has N pixels in a vertical direction and N pixels in a horizontal direction, where N represents a nonnegative integer value. The pixels in a block may be arranged in rows and columns. Moreover, blocks need not necessarily have the same number of pixels in the horizontal direction as in the vertical direction. For example, blocks may comprise rectangular areas with N×M pixels, where M is not necessarily equal to N.

Following intra-predictive or inter-predictive coding to produce a PU for a CU, video encoder 20 may calculate residual data to produce one or more transform units (TUs) for the CU. The residual data may correspond to pixel differences between pixels of the unencoded picture and prediction values of a PU of a CU. Video encoder 20 may form one or more TUs including the residual data for the CU. Video encoder 20 may then transform the TUs. Prior to application of a transform, such as a discrete cosine transform (DCT), an integer transform, a wavelet transform, or a conceptually similar transform, TUs of a CU may comprise residual video data in the pixel domain. Following application of the transform, the TUs may comprise transform coefficients that represent the residual video data in the frequency domain.

Following any transforms to produce transform coefficients, quantization of transform coefficients may be performed. Quantization generally refers to a process in which transform coefficients are quantized to possibly reduce the amount of data used to represent the coefficients. The quantization process may reduce the bit depth associated with some or all of the coefficients. For example, an n-bit value may be rounded down to an m-bit value during quantization, where n is greater than m.

Video encoder 20 may apply a zig-zag scan or another scan order associated with a size of the TU to scan the quantized transform coefficients to produce a serialized vector that can be entropy encoded. In some examples, video encoder 20 may utilize a predefined scan order to scan the quantized transform coefficients. In other examples, video encoder 20 may perform an adaptive scan. After scanning the quantized transform coefficients to form a one-dimensional vector, video encoder 20 may entropy encode the one-dimensional vector of coefficients, e.g., according to context adaptive variable length coding (CAVLC), context adaptive binary arithmetic coding (CABAC), or another entropy encoding methodology. Video encoder 20 may also entropy encode syntax elements for a given coding unit (CU), video slice, video frame, and/or video sequence to be coded. The syntax elements may include one or more of CU information, prediction information, coded block patterns, and significance maps.

To perform entropy encoding, video encoder 20 selects contexts for video data symbols, e.g., coefficients and syntax elements, to determine probability estimates for values of the video data symbols according to a context model. In the case of CABAC, video data symbols may be represented by binary bits, i.e., bins, and each of the bins may then be arithmetically encoded based on probability estimates for the bins. A probability state may represent the probability estimate for each bin. In the case of CAVLC, video data symbols may be encoded using variable length codewords defined in one or more VLC tables based on probability estimates for the video data symbols. The variable length codewords may be designed such that more probable values of the video data symbols may be encoded using shorter codewords. Video decoder 30 may operate in a manner essentially symmetrical to that of video encoder 20.

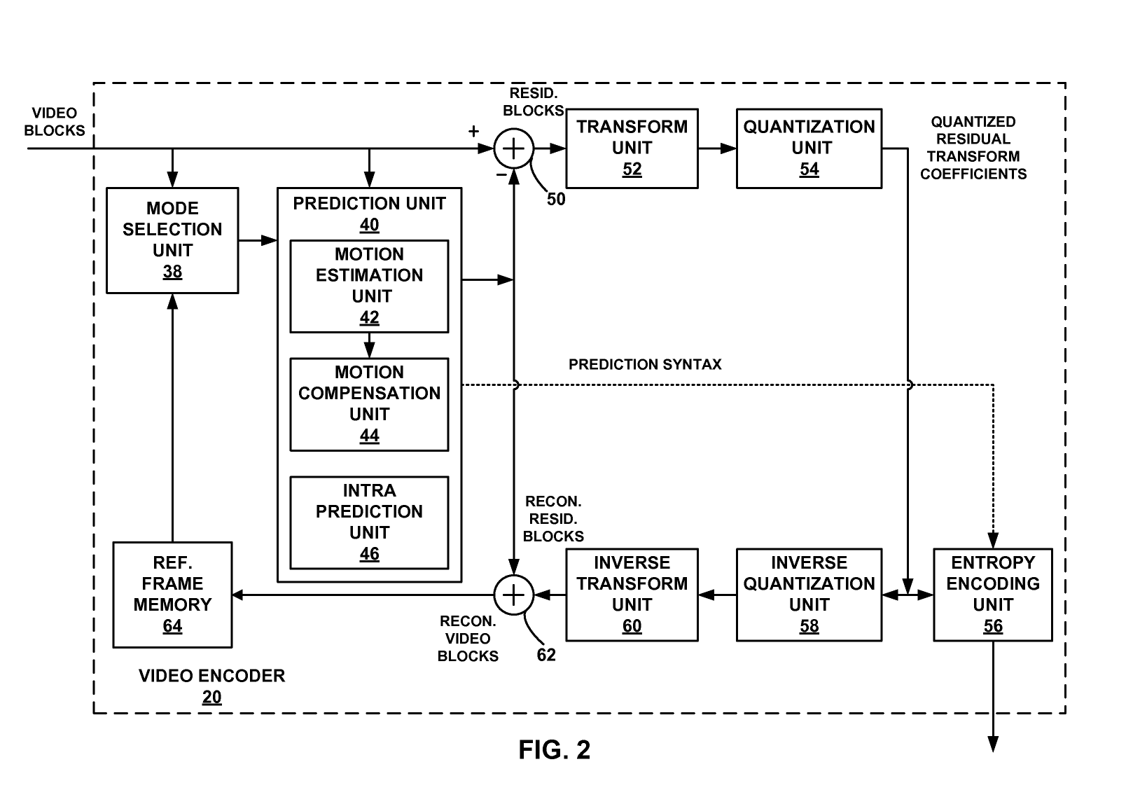

FIG. 2 is a block diagram illustrating an example video encoder that may implement techniques for entropy encoding bins across bin groups using variable length codewords. Video encoder 20 may perform intra- and inter-coding of coding units within video frames. Intra-coding relies on spatial prediction to reduce or remove spatial redundancy in video within a given video frame. Inter-coding relies on temporal prediction to reduce or remove temporal redundancy in video within adjacent frames of a video sequence. Intra-mode (I mode) may refer to any of several spatial based compression modes. Inter-modes such as unidirectional prediction (P mode), bidirectional prediction (B mode), or generalized P/B prediction (GPB mode) may refer to any of several temporal-based compression modes.

In the example of FIG. 2, video encoder 20 includes mode selection unit 38, prediction unit 40, summer 50, transform unit 52, quantization unit 54, entropy encoding unit 56, and reference frame memory 64. Prediction unit 40 includes motion estimation unit 42, motion compensation unit 44, and intra prediction unit 46. For video block reconstruction, video encoder 20 also includes inverse quantization unit 58, inverse transform unit 60, and summer 62. A deblocking filter (not shown in FIG. 2) may also be included to filter block boundaries to remove blockiness artifacts from reconstructed video. If desired, the deblocking filter would typically filter the output of summer 62.

As shown in FIG. 2, video encoder 20 receives a video block within a video frame or slice to be encoded. The frame or slice may be divided into multiple video blocks or CUs. Mode selection unit 38 may select one of the coding modes, intra or inter, for the video block based on error results. Prediction unit 40 then provides the resulting intra- or inter-coded predictive block to summer 50 to generate residual block data, and to summer 62 to reconstruct the encoded block for use as a reference block in a reference frame.

Intra prediction unit 46 within prediction unit 40 performs intra-predictive coding of the video block relative to one or more neighboring blocks in the same frame as the video block to be coded. Motion estimation unit 42 and motion compensation unit 44 within prediction unit 40 perform inter-predictive coding of the video block with respect to one or more reference blocks in one or more reference frames stored in reference frame memory 64. Motion estimation unit 42 and motion compensation unit 44 may be highly integrated, but are illustrated separately for conceptual purposes. Motion estimation, performed by motion estimation unit 42, is the process of generating motion vectors, which estimate motion for video blocks. A motion vector, for example, may indicate the displacement of a video block or PU within a current video frame relative to a reference block or PU within a reference frame. A reference block is a block that is found to closely match the video block or PU to be coded in terms of pixel difference, which may be determined by sum of absolute difference (SAD), sum of square difference (SSD), or other difference metrics.

Motion estimation unit 42 sends the calculated motion vector to motion compensation unit 44. Motion compensation, performed by motion compensation unit 44, may involve fetching or generating the predictive block based on the motion vector determined by motion estimation. Video encoder 20 forms a residual video block by subtracting the predictive block from the video block being coded. Summer 50 represents the component or components that perform this subtraction operation.

Motion compensation unit 44 may generate syntax elements defined to represent prediction information at one or more of a video sequence level, a video frame level, a video slice level, a video coding unit (CU) level, or a video prediction unit (PU) level. For example, motion compensation unit 44 may generate syntax elements indicating CU information including sizes of CUs, PUs, and TUs, and motion vector information for intra-mode prediction.

After video encoder 20 forms the residual video block by subtracting the predictive block from the current video block, transform unit 52 may form one or more transform units (TUs) from the residual block. Transform unit 52 applies a transform, such as a discrete cosine transform (DCT), an integer transform, a wavelet transform, or a conceptually similar transform, to the TU to produce a video block comprising residual transform coefficients. The transform may convert the residual block from a pixel domain to a transform domain, such as a frequency domain. More specifically, prior to application of the transform, the TU may comprise residual video data in the pixel domain, and, following application of the transform, the TU may comprise transform coefficients that represent the residual video data in the frequency domain.

Transform unit 52 may send the resulting transform coefficients to quantization unit 54. Quantization unit 54 quantizes the transform coefficients to further reduce bit rate. The quantization process may reduce the bit depth associated with some or all of the coefficients. The degree of quantization may be modified by adjusting a quantization parameter. Entropy encoding unit 56 or quantization unit 54 may then perform a scan of the TU including the quantized transform coefficients. Entropy encoding unit 56 may apply a zig-zag scan or another scan order associated with a size of the TU to scan the quantized transform coefficients to produce a serialized vector that can be entropy encoded.

After scanning the quantized transform coefficients to form a one-dimensional vector, entropy encoding unit 56 entropy codes the vector of quantized transform coefficients. Video encoder 20 may also entropy encode syntax elements for a given coding unit (CU), video slice, video frame, and/or video sequence to be encoded. The syntax elements may include one or more of CU information, prediction information, coded block patterns, and significance maps. For example, entropy encoding unit 56 may perform CAVLC, CABAC, or another entropy encoding technique. Following the entropy encoding by entropy encoding unit 56, the encoded bitstream may be transmitted to a video decoder, such as video decoder 30, or archived for later transmission or retrieval.

To perform entropy encoding, entropy encoding unit 56 selects contexts for video data symbols, e.g., coefficients and syntax elements, to determine probability estimates for values of the video data symbols according to a context model. In the case of CABAC, non-binary valued video data symbols may be binarized into bins; the binarization step may be skipped for video data symbols that are already binary valued. Each of the bins may then be arithmetically encoded based on probability estimates for the bins. The contexts for each bin may be selected based on at least one of a symbol category associated with the bin, a number of the bin within the sequence of bins, and values of previously coded bins. A context model specifies how to select the context to determine a probability estimate for a value (e.g., 0 or 1) of the bin based on the neighboring values. A probability state may represent the probability estimate for each bin. In the case of CAVLC, entropy encoding unit 56 may encode video data symbols using variable length codewords defined in one or more VLC tables based on probability estimates for values of the video data symbols. The variable length codewords may be designed such that more probable values of the video data symbols may be encoded using shorter codewords.

Conventionally, entropy coding techniques may cause bottlenecks within entropy encoding unit 56 during the entropy coding process. For example, CABAC provides low throughput due to bin level serial processing. For example, in a video encoder, several bins may be input to an arithmetic encoder in order to output a single encoded bit. Due to the bin level serial processing, only a single bin may be encoded during each clock cycle such that it may take several clock cycles to encode the single output bit. The same is also true in a video decoder, in which one input bit to an arithmetic decoder may result in several decoded output bins, one per clock cycle. In order to avoid this bottleneck, the entropy coding process may be parallelized and/or modified to use variable length coding instead of arithmetic coding.

In one solution, a sequence of bins representing video data symbols may be divided into context groups, and the bins in each of the context groups may be entropy encoded in parallel using a different arithmetic coding engine for each context group. The context groups may be defined such that bins in one of the context groups do not have context dependencies with bins in another of the context groups. For example, each of the context groups may include bins representing a different type of syntax element.

In another solution, a sequence of bins representing video data symbols may be divided into probability groups, and the bins in each of the probability groups may be entropy encoded in parallel using a different arithmetic coding engine for each probability group. The probability groups may be defined according to different intervals such that bins in each of the probability groups have probability states within the interval associated with the probability group. The intervals associated with the probability groups may, for example, be determined by dividing a range of all possible probability states into discrete ranges of probability states. In some examples, the bins in each of the probability groups may be entropy encoded in parallel using variable-to-variable length (V2V) entropy coding instead of arithmetic coding.

The parallel V2V entropy coding provides higher throughput than CABAC, but requires large amounts of buffering while waiting to form valid V2V codewords for different bin groups. This bottleneck occurs because a video decoder expects to receive the codewords in a certain order. The parallel entropy encoders, therefore, must perform bin and codeword buffering while waiting for a first encoder to receive enough bins in the associated probability group to form a valid codeword. More specifically, the other entropy encoders must buffer any received bins and any completed variable length codewords until all previous encoders in the order have formed codewords.

According to the techniques of this disclosure, entropy encoding unit 56 may be configured to perform entropy encoding of bins grouped into bin subsets from across bin groups, e.g., context groups or probability groups, using variable length codewords. In some examples, the techniques may enable bins to be groups into bin subsets from across a combination of both context groups and probability groups. The disclosed techniques enable entropy encoding unit 56 to achieve high throughput while reducing an amount of bin and codeword buffering by efficiently forming the bin subsets and designing variable length codewords for each of the bin subsets.

In one example, entropy encoding unit 56 may first binarize one or more video data symbols that are not already binary valued into binary bits, i.e., bins. Entropy encoding unit 56 may skip the binarization step for video data symbols that are already binary valued. Entropy encoding unit 56 then selects contexts for each of the bins in a sequence of bins. Entropy encoding unit 56 may then assign each of the bins in the sequence of bins to one of a plurality of context groups based on the context of the bin. The different context groups may be defined such that there are no context dependencies between bins in each of the context groups. Each of the context groups may, therefore, include bins associated with a certain type of syntax element because contexts for one type of syntax element have no bearing on contexts for another type of syntax element.

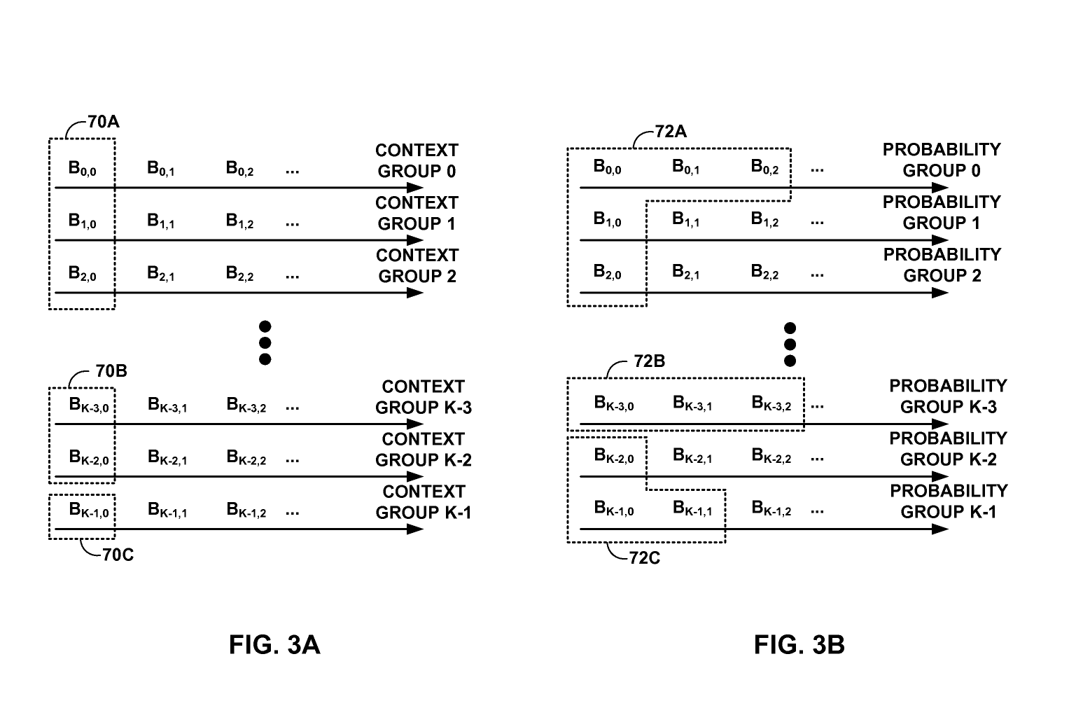

Entropy encoding unit 56 then groups bins from across one or more of the context groups into bin subsets based on determined formations of the bin subsets. The different bin subsets may be defined according to the determined formations of the bin subsets that define one bin from one or more context groups included in each of the bin subsets. The determined formations of the bin subsets may be determined based on frequency of bin occurrence in each of the context groups and overall efficiency of variable length codewords designed for each of the bin subsets. In this way, the bin subsets may be defined so as to be filled with the appropriate types of bins to form variable length codewords in the most efficient manner while minimizing the amount of buffering required by entropy encoding unit 56. Examples of determined formations of the bin subsets from across context groups are illustrated in FIG. 3A.

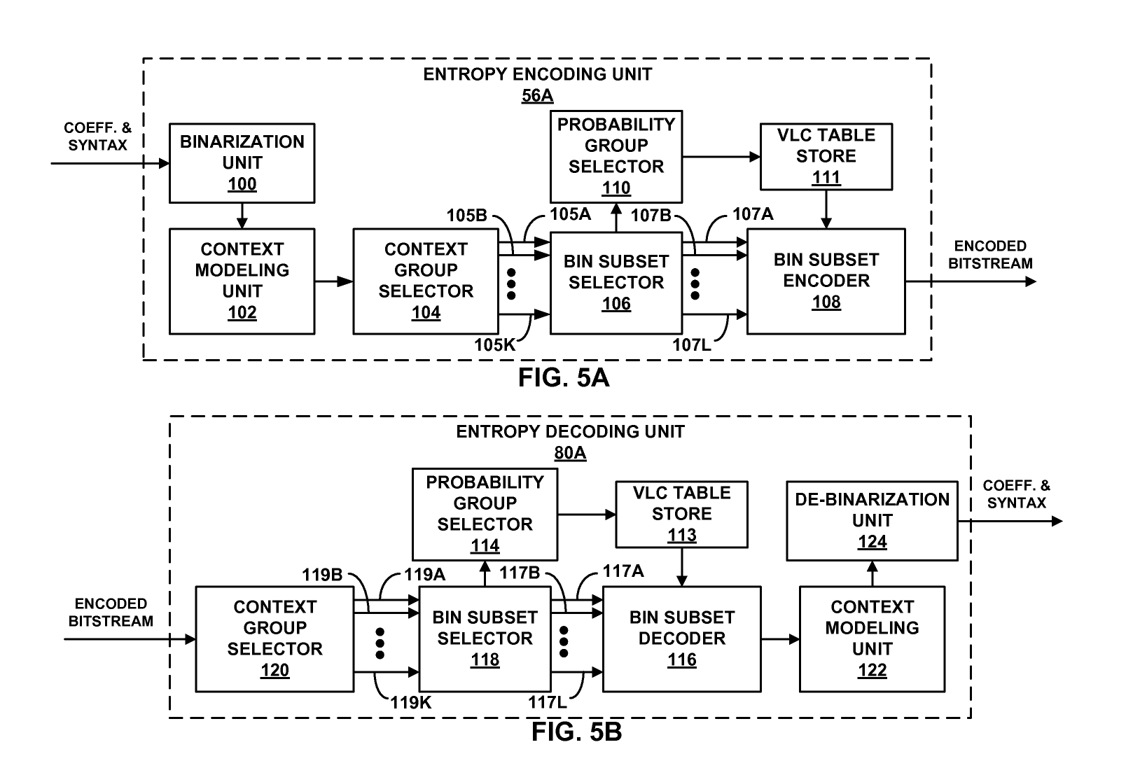

Entropy encoding unit 56 then entropy encodes the bins in each of the bin subsets using variable length codewords designed for the bin subset. One or more variable length codewords may be designed for each of the bin subsets based on the determined formation of the bin subset. More specifically, a different variable length codeword may be designed for each of the potential input values of the bins in each of the bin subsets. In addition, the variable length codewords may be designed based on probability estimates for the potential input values. The functions of entropy encoding unit 56 when configured to entropy encode bins from across context groups are described in more detail with respect to FIG. 5A.

As another example, entropy encoding unit 56 may first binarize one or more video data symbols that are not already binary valued into binary bits, i.e., bins. Entropy encoding unit 56 may skip the binarization step for video data symbols that are already binary valued. Entropy encoding unit 56 then determines probability states associated with contexts for each of the bins in a sequence of bins. The probability states represent probability estimates for values of the bins associated with the contexts of the bins in context models.

Entropy encoding unit 56 may then assign each of the bins in the sequence of bins to one of a plurality of probability groups based on a probability state associated with the context of the bin. In this way, entropy encoding unit 56 may only need to keep track of a probability state of each bin, and not the actual context assigned to the bin. The different probability groups may be defined according to different intervals such that bins in each of the probability groups have probability states within the interval associated with the probability group. The intervals associated with the probability groups may, for example, be determined by dividing a range of all possible probability states into discrete ranges of probability states.

Entropy encoding unit 56 then groups bins from across one or more of the probability groups into bin subsets based on determined formations of the bin subsets. The different bin subsets may be defined according to the determined formations of the bin subsets that define a number of bins from one or more probability groups included in each of the bin subsets. The determined formations of the bin subsets may be determined based on frequency of bin occurrence in each of the probability groups and overall efficiency of variable length codewords designed for each of the bin subsets. In this way, the bin subsets may be defined so as to be filled with the appropriate types of bins to form variable length codewords in the most efficient manner while minimizing the amount of buffering required by entropy encoding unit 56. Examples of determined formations of the bin subsets from across probability groups are illustrated in FIG. 3B.

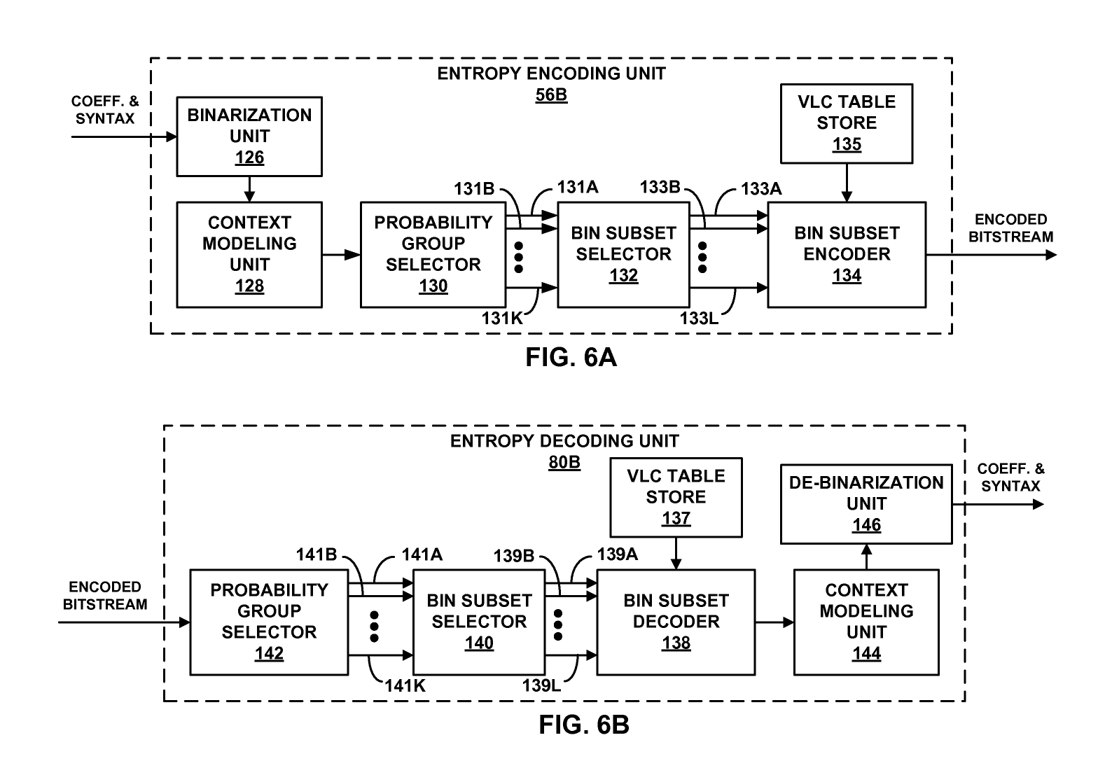

Entropy encoding unit 56 then entropy encodes the bins in each of the bin subsets using variable length codewords designed for the bin subset. One or more variable length codewords may be designed for each of the bin subsets based on the determined formation of the bin subset. More specifically, a different variable length codeword may be designed for each of the potential input values of the bins in each of the bin subsets. In addition, the variable length codewords may be designed based on probability estimates for the potential input values. The functions of entropy encoding unit 56 when configured to entropy encode bins from across probability groups are described in more detail with respect to FIG. 6A.

According to the techniques of this disclosure, the types of bins included in each of the bin subsets may be determined based on frequency of bin occurrence in each of the bin groups, e.g., context groups or probability groups. The bin subsets may also be defined so as to be filled with the appropriate types of bins to form variable length codewords in the most efficient manner.

A bin subset encoder has to wait to receive all the bins included in a given bin subset to form a valid variable length codeword. If the frequency of occurrence of different bins included in the bin subset varies a great deal, a large amount of buffering may be needed at the bin subset encoder before all of the bins included in the bin subset are available for encoding. The techniques may reduce the amount of buffering by including bins from bin groups that occur with similar frequency in the bin subsets. In the case of probability groups, the techniques may further reduce the amount of buffering by including multiple bins from probability groups that occur more frequently in the bin subsets. In this way, bins and completed codewords for the bin subsets only require a minimal amount of buffering in the bin subset encoder while waiting for a first valid codeword to be constructed for the first bin subset. The techniques, therefore, reduce an amount of bin and codeword buffering performed by the bin subset encoder.

In some examples, an issue may arise because the number of bins in each of the bin groups, e.g., context groups or probability groups, are not necessarily equal across the groups. At some point in the encoding process, therefore, a bin subset encoder within entropy encoding unit 56 may stop receiving bins from a bin group that is required to form a next codeword for a bin subset. In this case, the bin subset encoder cannot form the next codeword and will continually buffer bins and completed codewords for other bin subsets during the subsequent clock cycles.

In order to avoid this issue, the techniques described herein enable entropy encoding unit 56 to switch to a V2V entropy coding process if no codewords are formed for a period of time. For example, if the bin subset encoder is unable to form a next codeword after a predetermined number of clock cycles, e.g., 100 clock cycles, entropy encoding unit 56 may instead use a V2V entropy coding process, described above in more detail, to form codewords for the bins in each of the bin groups. In another example, video encoder 20 may include a syntax element in the slice header that indicates when the entropy encoding unit 56 may switch to the V2V entropy coding process to form codewords for the bins in each of the bin groups. The syntax element may indicate a number of clock cycles or a number of bits after which the entropy coding process may switch. In case of context groups, the V2V entropy coding process may be applied to each context group. In case of probability groups, the V2V entropy coding process may be applied to each probability group.

Inverse quantization unit 58 and inverse transform unit 60 apply inverse quantization and inverse transformation, respectively, to reconstruct the residual block in the pixel domain for later use as a reference block of a reference frame. Summer 62 adds the reconstructed residual block to the predictive block generated by motion compensation unit 44 to produce a reference block for storage in reference frame memory 64. The reference block may be used by motion estimation unit 42 and motion compensation unit 44 as a reference block to inter-predict a block in a subsequent video frame.

FIG. 3A is a conceptual diagram illustrating exemplary determined formations of bin subsets from across different context groups. The determined formations of bin subsets define a number of bin subsets, and one bin from one or more context groups included in each of bin subsets. The determined formations of the bin subsets illustrated in FIG. 3A are merely exemplary. In operation, the formations of the bin subsets may be determined to include one bin from across one or more context groups based on frequency of bin occurrence in each of the context groups and overall efficiency of variable length codewords designed for each of the bin subsets. In this way, the bin subsets may be defined so as to be filled with the appropriate types of bins to form variable length codewords in the most efficient manner while minimizing the amount of buffering required by the bin subset encoder. The determined formations of the bin subsets may be pre-determined based on simulations using a plurality of video sequences and fixed for both a video encoder and a video decoder.

In the illustrated example, bin groups 0 through K-1 comprise context groups. In other examples, one or more of the bin groups may comprise probability groups. In the illustrated example of FIG. 3A, entropy encoding unit 56 within video encoder 20 from FIG. 2 groups one bin from across one or more of the K context groups into bin subsets 70A, 70B and 70C based on determined formations of the bin subsets. The determined formations of the bin subsets may define a first bin subset 70A for the first bins in a first portion of the context groups that includes context group 0, context group 1, and context group 2. In addition, the determined formations define a second bin subset 70B for the first bins in a second portion of the context groups that includes context group K-3 and context group K-2. Finally, the determined formations define a third bin subset 70C for the first bins in a third portion of the context groups that includes context group K-1.

The three bin subsets 70A-70C illustrated in FIG. 3A are merely exemplary. In other cases, more or fewer bin subsets may be defined to include one bin from across one or more of context groups 0 through K-1. For example, the determined formations of the bin subsets may define a first bin subset for all the first bins in each of the bin groups 0 through K-1.

FIG. 3B is a conceptual diagram illustrating exemplary determined formations of bin subsets from across different probability groups. The determined formations of bin subsets define a number of bin subsets, and a number of bins from one or more probability groups included in each of bin subsets. The determined formations of the bin subsets illustrated in FIG. 3B are merely exemplary. In operation, the formations of the bin subsets may be determined to include any or one or more bins from across one or more probability groups based on frequency of bin occurrence in each of the probability groups and overall efficiency of variable length codewords designed for each of the bin subsets. In this way, the bin subsets may be defined so as to be filled with the appropriate types of bins to form variable length codewords in the most efficient manner while minimizing the amount of buffering required by the bin subset encoder. The determined formations of the bin subsets may be pre-determined based on simulations using a plurality of video sequences and fixed for both a video encoder and a video decoder.

In the illustrated example of FIG. 3B, entropy encoding unit 56 within video encoder 20 from FIG. 2 groups one or more bins from across one or more of K probability groups into bin subsets 72A, 72B and 72C based on determined formations of the bin subsets. In this case, bin groups 0 through K-1 comprise probability groups. The determined formations of the bin subsets define a first bin subset 72A for the first bin, second bin, and third bin in bin group 0, a first bin in bin group 1, and a first bin in bin group 2. In addition, the determined formations define a second bin subset 72B for the first bin, second bin, and third bin in only bin group K-3. Finally, the determined formations define a third bin subset 72C for the first bin in bin group K-2 and the first bin and second bin in bin group K-1. The three bin subsets 72A-70C illustrated in FIG. 3B are merely exemplary. In other cases, more or fewer bin subsets may be defined to include one or more bins from across one or more of probability groups 0 through K-1.

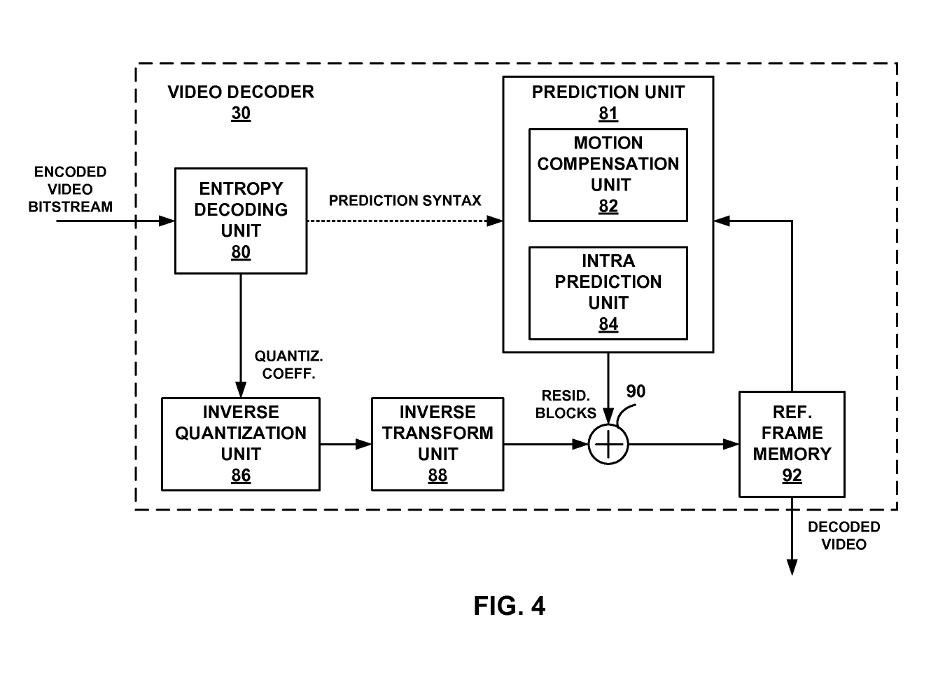

FIG. 4 is a block diagram illustrating an example video decoder that may implement techniques for entropy decoding bins across bin groups using variable length codewords. In the example of FIG. 4, video decoder 30 includes an entropy decoding unit 80, prediction unit 81, inverse quantization unit 86, inverse transformation unit 88, summer 90, and reference frame memory 92. Prediction unit 81 includes a motion compensation unit 82, and an intra prediction unit 84. Video decoder 30 may, in some examples, perform a decoding pass generally reciprocal to the encoding pass described with respect to video encoder 20 (FIG. 2).

During the decoding process, video decoder 30 receives an encoded video bitstream that represents encoded video frames or slices and syntax elements that indicate coding information from video encoder 20. Entropy decoding unit 80 entropy decodes the bitstream to generate quantized transform coefficients within transform units (TUs) of a given coding unit (CU). Entropy decoding unit 80 also entropy decodes syntax elements for the coding unit (CU), video slice, video frame, and/or video sequence to be decoded. The syntax elements may include one or more of CU information, prediction information, coded block patterns, and significance maps. For example, entropy decoding unit 80 may perform CAVLC, CABAC, or another entropy decoding technique.

Conventionally, entropy coding techniques may cause bottlenecks within entropy decoding unit 80 during the entropy coding process. As described above, CABAC provides low throughput due to bin level serial processing. For example, in a video decoder, several output bins to be decoded may be generated from one bit input to an arithmetic decoder. Due to the bin level serial processing, only a single bin may be encoded during each clock cycle such that it may take several clock cycles to decode the single input bit into the multiple output bits. The same is also true in a video encoder, in which several bins may be input to an arithmetic encoder in order to output a single encoded bit. In order to avoid this bottleneck, the entropy coding process may be parallelized and/or modified to use variable length coding instead of arithmetic coding.

The solutions described above with respect to entropy encoding may provide higher throughput than CABAC in both a video encoder and decoder, but require large amounts of buffering at the video encoder while waiting to form valid V2V codewords for different bin groups. This bottleneck occurs because the video decoder expects to receive the codewords in a certain order.

According to the techniques of this disclosure, entropy decoding unit 80 may perform entropy decoding of bins grouped into bin subsets from across bin groups, e.g., context groups or probability groups, using variable length codewords. In some examples, the techniques may enable bins to be grouped into bin subsets from across a combination of both context groups and probability groups.

In one example, entropy decoding unit 80 first selects a context for a next bin in the sequence of bins to be decoded into video data symbols based on a request for the next bin. Entropy decoding unit 80 may then select one of a plurality of context groups to which the next bin is assigned based on the context of the next bin. The context groups in entropy decoding unit 80 may be defined in the same way as the context groups in entropy encoding unit 56 from FIG. 2. For example, the different context groups may be defined such that there are no context dependencies between bins in each of the context groups. The context groups may be formed such that the bin values from one context group do not affect the contexts of bins in another context group. As an example, bins with contexts used for coding motion vector differences may be placed in one context group whereas bins with contexts corresponding to transform coefficient significant map coding and level coding may be placed in another context group.

Entropy decoding unit 80 then selects one of the bin subsets in which the next bin is grouped with bins from across one or more of the context groups based on determined formations of the bin subsets. The bin subsets in entropy decoding unit 80 may be defined in the same way as the bin subsets in entropy encoding unit 56 from FIG. 2. For example, the different bin subsets may be defined according to the determined formations of the bin subsets that define one bin from one or more of the context groups included in each of the bin subsets.

Entropy decoding unit 80 then entropy decodes the variable length codeword associated with the selected bin subset into bins, including the next bin, in the selected bin subset. Entropy decoding unit 80 may fill the decoded bin values into the selected bin subset. If any of the decoded bins represents a portion of a non-binary valued video data symbol, such as a syntax element, entropy decoding unit 80 may de-binarize one or more decoded bins into the video data symbol. The functions of entropy decoding unit 80 when configured to entropy decode bins from across context groups are described in more detail with respect to FIG. 6A.

As another example, entropy decoding unit 80 may first determine a probability state associated with a context of a next bin in the sequence of bins to be decoded into video data symbols based on a request for the next bin. The probability state represents a probability estimate for a value of the next bin associated with the context of the next bin in a context model. Entropy decoding unit 80 may then select one of a plurality of probability groups to which the next bin is assigned based on a probability state associated with the context of the next bin. In this way, entropy decoding unit 80 may only need to keep track of a probability state of each bin, and not the actual context assigned to the bin. The probability groups in entropy decoding unit 80 may be defined in the same way as the probability groups in entropy encoding unit 56 from FIG. 2. For example, the different probability groups may be defined according to different intervals such that bins in each of the probability groups have probability states within the interval associated with the probability group. The intervals associated with the probability groups may, for example, be determined by dividing a range of all possible probability states into discrete ranges of probability states.

Entropy decoding unit 80 then selects one of the bin subsets in which the next bin is grouped with bins from across one or more of the probability groups based on determined formations of the bin subsets. The bin subsets in entropy decoding unit 80 may be defined in the same way as the bin subsets in entropy encoding unit 56 from FIG. 2. For example, the different bin subsets may be defined according to the determined formations of the bin subsets that define a number of bins from one or more of the probability groups included in each of the bin subsets.

Entropy decoding unit 80 then entropy decodes the variable length codeword associated with the selected bin subset into bins, including the next bin, in the selected bin subset. Entropy decoding unit 80 may fill the decoded bin values into the selected bin subset. If any of the decoded bins represents a portion of a non-binary valued video data symbol, such as a syntax element, entropy decoding unit 80 may de-binarize one or more decoded bins into the video data symbol. The functions of entropy decoding unit 80 when configured to entropy decode bins from across probability groups are described in more detail with respect to FIG. 6B.

Inverse quantization unit 86 inverse quantizes, i.e., de-quantizes, the quantized transform coefficients decoded into TUs by entropy decoding unit 80, as described above. The inverse quantization process may include use of a quantization parameter Qp calculated by video encoder 20 for each video block or CU to determine a degree of quantization and, likewise, a degree of inverse quantization that should be applied. Inverse transform unit 88 applies an inverse transform, e.g., an inverse DCT, an inverse integer transform, an inverse wavelet transform, or a conceptually similar inverse transform process, to the transform coefficients within the TUs in order to produce residual video data in the pixel domain.

Entropy decoding unit 80 also forwards decoded motion vectors and other prediction syntax elements to prediction unit 81. Video decoder 30 may receive the syntax elements at the video prediction unit level, the video coding unit level, the video slice level, the video frame level, and/or the video sequence level. When a video frame is coded as an intra-coded frame, intra prediction unit 84 of prediction unit 81 generates prediction data for video blocks of the current video frame based on data from previously decoded blocks of the current frame. When a video frame is coded as an inter-coded frame, motion compensation unit 82 of prediction unit 81 produces predictive blocks for video blocks of the current video frame based on the decoded motion vectors received from entropy decoding unit 80. The predictive blocks may be generated with respect to one or more reference blocks of a reference frame stored in reference frame memory 92.

Motion compensation unit 82 determines prediction information for a video block to be decoded by parsing the motion vectors and other prediction syntax, and uses the prediction information to generate the predictive blocks for the current video block being decoded. For example, motion compensation unit 82 uses some of the received syntax elements to determine sizes of CUs used to encode the current frame, split information that describes how each CU of the frame is split, modes indicating how each split is encoded (e.g., intra- or inter-prediction), an inter-prediction slice type (e.g., B slice, P slice, or GPB slice), reference frame list construction commands, interpolation filters applied to reference frames, motion vectors for each video block of the frame, video parameter values associated with the motion vectors, and other information to decode the current video frame.

Video decoder 30 forms a decoded video block by summing the residual blocks from inverse transform unit 88 with the corresponding predictive blocks generated by motion compensation unit 82. Summer 90 represents the component or components that perform this summation operation. If desired, a deblocking filter may also be applied to filter the decoded blocks in order to remove blockiness artifacts. The decoded video blocks are then stored in reference frames in reference frame memory 92, which provides reference blocks of reference frames for subsequent motion compensation. Reference frame memory 92 also produces decoded video for presentation on a display device, such as display device 32 of FIG. 1.

FIGS. 5A and 5B are block diagrams respectively illustrating an example entropy encoding unit 56A and an example entropy decoding unit 80A configured to entropy code bins from across context groups.

In FIG. 5A, entropy encoding unit 56A comprises one example of entropy encoding unit 56 included in video encoder 20 from FIG. 2. Entropy encoding unit 56A includes a binarization unit 100, a context modeling unit 102, a context group selector 104, a bin subset selector 106, a bin subset encoder 108, a probability group selector 110, and VLC tables 111. In the illustrated example of FIG. 5A, the techniques of this disclosure are directed toward performing entropy encoding of bins grouped into one or more of bin subsets 107A-L from across one or more of a plurality of context groups 105A-K using variable length codewords.

Entropy encoding unit 56A within video encoder 20 receives video data symbols, such as quantized transform coefficients and syntax elements, for a coding unit (CU) to be entropy encoded for storage or transmission to video decoder 30. Binarization unit 100 may binarize or map video data symbols that are not already binary valued into bins in a sequence of bins. As an example, binarization unit 100 may map a value of a syntax element that is not binary valued to a particular sequence of bins, where each bin has a value of 0 or 1. The location of each bin, e.g., first, second, etc., in the sequence of bins representing the syntax element may be referred to as its bin number. Entropy encoding unit 56A may skip the binarization step for video data symbols that are already binary valued. As an example, a syntax element may already have a value of either 0 or 1 such that an additional binarization step is unnecessary.

Context modeling unit 102 receives a sequence of bins that includes bins representing one or more of the coefficients and the syntax elements for the CU to be encoded, including motion vector differences (MVDs), the split of the LCU into CUs, and the transform quadtree. Context modeling unit 102 selects contexts for each of the bins in the sequence of bins. The contexts for each bin may be selected based on at least one of a symbol category associated with the bin, a number of the bin within the sequence of bins, and values of previously coded bins. A context model specifies how to select the context of the bin to determine a probability estimate for a value (e.g., 0 or 1) of the bin. Let context(i) denote the context for bin number i, where i=0, 1, 2, . . . , N. Each different context index is associated with one of a plurality of probability estimates maintained by context modeling unit 102. Context modeling unit 102 updates the probability estimate associated with the context of the bin based on the actual value of the bin.

Context group selector 104 assigns each of the bins to a selected one of context groups 105A-K based on the context of the bin. Context groups 105A-K may be defined such that there are no context dependencies between bins in each of context groups 105A-K. Each of the context groups 105A-K may be formed such that the bin values from one context group do not affect the contexts of bins in another context group. As an example, bins with contexts used for coding motion vector differences may be placed in one context group whereas bins with contexts corresponding to transform coefficient significant map coding and level coding may be placed in another context group.

In one example, the context groups 105A-K may include bins that represent syntax elements, including one or more of coding unit (CU) information, prediction information, coded block patterns, and significance maps, along with quantized transform coefficients of the CU to be encoded. In this example, therefore, entropy encoding unit 56A may include five context groups one for each type of syntax element. In other examples, each of context groups 105A-K may be associated with different types of syntax elements and different entropy encoding unit 56A may include a different number of context groups. In further examples, each of context groups 105A-K may not be associated with any particular types of syntax elements, but may be defined based only on context dependencies.

Bin subset selector 106 groups bins from across one or more of context groups 105A-K into a selected one of bin subsets 107A-L based on determined formations of the bin subsets. The determined formations of the bin subsets define a number of bin subsets 107A-L and one bin from one or more context groups 105A-K included in each of bin subsets 107A-L. The determined formations of the bin subsets may be determined based on frequency of bin occurrence in each of context groups 105A-K and overall efficiency of variable length codewords designed for each of the bin subsets. In this way, bin subsets 107A-L may be defined so as to be filled with the appropriate types of bins to form variable length codewords in the most efficient manner while minimizing the amount of buffering required by bin subset encoder 108. The determined formations of the bin subsets may be pre-determined based on simulations using a plurality of video sequences and fixed for both a video encoder and a video decoder.

As one example, the determined formations of the bin subsets may define a first bin subset 107A for all the first bins in each of context groups 105A-K. As illustrated in FIG. 3A, the determined formations of the bin subsets may define a first bin subset 107A for all the first bins in a first portion of context groups 105A-K that comprises less than all of the context groups, and a second bin subset 107B for all the first bins in a second portion of context groups 105A-K. In other examples, more or fewer bin subsets 107A-L may be defined to include one bin from across one or more of context groups 105A-K.

Bin subset encoder 108 entropy encodes the bins in respective bin subsets 107A-L into variable length codewords. For example, once the types of bins determined for first bin subset 107A are received by bin subset encoder 108, bin subset encoder 108 encodes the bins within first bin subset 107A into a variable length codeword. Bin subset encoder 108 may similarly encode bins within second bin subset 107B through to bins within Lth bin subset 107L, depending on a given encoding order. In other examples, entropy encoding unit 56A may include a plurality of bin subset encoders capable of respectively encoding bins in each of bin subsets 107A-L in parallel. In may be possible if all data associated with each of the bin subsets is kept separate in the encoded bitstream, i.e., data across different bin subsets may not be interleaved.

As described above, each of context groups 105A-K may include bins having one or more contexts, and each of the contexts are associated with a different probability estimate or state. For each of bin subsets 107A-L, therefore, it is unknown what combination of contexts of the bins may be included in the bin subsets. In one example, bin subset encoder 108 may select a different VLC table from VLC table store 111 for each different combination of contexts of the bins included in each of bin subsets 107A-L. For example, if bin subset 107A includes the first bins in each of context group 105A and context group 105B, and each of context groups 105A and 105B may include bins having 50 different contexts, then 50*50 different VLC tables may need to be created in VLC table store 111 for bin subset 107A. This is an undesirably large number of VLC tables to store for each bin subset.

In another example, probability group selector 110 may further assign each of the bins in each of context groups 105A-K to a probability group based on a probability state of the bin associated with the context of the bin. Each of the probability groups may be defined according to a different interval that includes a discrete range of probability states from the range of all possible probability states. For example, a range of possible probability states from 0 to 128 may be divided into twelve discrete intervals of probability states, each associated with one of the probability groups. In this case, each of the probability groups has a representative probability associated with that probability group.

In this case, bin subset encoder 108 may select a different VLC table from VLC table store 111 for each different combination of representative probability states of the bins included in each of bin subsets 107A-L. For example, if bin subset 107A includes the first bins in each of context group 105A and context group 105B, and each of context groups 105A and 105B may include bins having 12 different representative probability states, then 12*12 different VLC tables may need to be created in VLC table store 111 for bin subset 107A. In other examples, fewer probability groups may be used to further reduce a number of VLC tables. Assigning the bins to probability groups, therefore, may severely reduce a number of possible combinations of probabilities of the bins in each bin subset and reduce a number of VLC tables for a given bin subset.

One or more variable length codewords may be designed in each of the VLC tables created in VLC table store 111 for each of bin subsets 107A-L. The VLC codewords in a given VLC table may be based on the combination of contexts of the bins. If one of bin subsets 107A-L is defined to include N different types of bins, there are 2^{N} potential input values of the N bins in the bin subset. For example, when bin subset 107A includes 3 different types of bins, there are 8 potential input values 000, 001, 010, 011, 100, 101, 110, and 111 in bin subset 107A. A different variable length codeword may be designed in a respective VLC table for each of the potential input values of the bins in one of bin subsets 107A-L. In addition, the variable length codewords may be designed based on probability estimates for the potential input values. For example, the most probable one of the potential input values to the VLC table may be encoded using the shortest variable length codeword, and the least probable one of the potential input values to the VLC table may be encoded using the longest variable length codeword. The variable length codewords designed in each of the VLC tables for each of bin subsets 107A-L may be pre-designed or may be adaptively designed for each CU, video slice, video frame, or video sequence.

The variable length codewords may be transmitted to video decoder 30 in a predetermined order. For example, video decoder 30 may expect to receive the codeword for first bin subset 107A first, followed by the codeword for second bin subset 107B second, and so on until the codeword for the Lth bin subset 107B. In order to send the variable length codewords in the predetermined order, bin subset encoder 108 may have to perform bin and codeword buffering. For example, while waiting to receive all the bins within first bin subset 107A, bin subset encoder 108 must buffer any received bins for bin subsets 107B-L and any completed variable length codewords for bin subsets 107B-L.

According to the techniques of this disclosure, the types of bins included in each of bin subsets 107A-L may be determined based on frequency of bin occurrence in each of context groups 105A-K. Bin subsets 107A-L may also be defined so as to be filled with the appropriate types of bins to form variable length codewords in the most efficient manner given the occurrence of the bins for the CU to be encoded. Bin subset encoder 108 has to wait to receive at least one bin of each type included in bin subset 107A to form a valid variable length codeword, and the types of bins included in bin subset 107A. If the frequency of occurrence of different bins included in bin subset 107A varies a great deal, a large amount of buffering may be needed at bin subset encoder 108 before all of the bins included in bin subset 107A are available for encoding. The techniques may reduce the amount of buffering by including bins from bin groups 105A-K that occur with similar frequency in bin subsets 107A-L. In this way, bins and completed codewords for bin subsets 107B-L only require a minimal amount of buffering in bin subset encoder 108 while waiting for a first valid codeword to be constructed for first bin subset 107A. The techniques, therefore, reduce an amount of bin and codeword buffering performed by bin subset encoder 108.

In other examples, entropy encoding unit 56A may not necessarily group bins from across context groups 105A-K into one or more bin subsets 107A-L. In this case, entropy encoding unit 56A may assign each of the bins in context groups 105A-K to a probability group, and then entropy encode the bins in each of context groups 105A-K using a VLC table for the combination of probability states in the context group. When the complexity and/or the bottlenecks in the entropy coding process become prohibitively large, however, entropy encoding unit 56A group the bins across context groups 105A-K into bin subsets 107A-L.

In FIG. 5B, entropy decoding unit 80A comprises one example of entropy decoding unit 80 included in video decoder 30 from FIG. 4. Entropy decoding unit 80A includes , bin subset decoder 116, a bin subset selector 118, a context group selector 120, a context modeling unit 122, and a de-binarization unit 124. Entropy decoding unit 80 also includes a VLC table store 113 and probability group selector 114. In the illustrated example of FIG. 5B, the techniques of this disclosure are directed toward performing entropy decoding of variable length codewords into bins grouped into one or more bin subsets 117A-L from across one or more of a plurality of context groups 119A-K.

Entropy decoding unit 80A within video decoder 30 receives an encoded bitstream of variable length codewords from video encoder 20. Video decoder 30 may receive the variable length codewords from video encoder 20 in a predetermined order. For example, video decoder 30 may expect to receive a codeword for first bin subset 117A first, followed by the codeword for second bin subset 117B second, and so on until the codeword for Lth bin subset 117L. In order to decode the variable length codewords into bins in each of bin subsets 117A-L context modeling unit 122 first selects a context for a next bin in the sequence of bins to be decoded into the video data symbols. For example, context modeling unit 122 may receive a request for the next bin, and determine the context for the next bin based on the bin request. In some cases, binarization unit 124 may first binarize the bin request. Context modeling unit 122 may determine a context for the next bin, and each additional requested bin in the sequence of bins to be decoded, in substantially the same way as context modeling unit 102 in entropy encoding unit 56A from FIG. 5A. For example, the context for the next bin may be selected based on at least one of a symbol category associated with the next bin, a number of the next bin within the sequence of bins, and values of previously decoded bins. A context model specifies how to select the context to determine a probability estimate for a value (e.g., 0 or 1) of the next bin.

Context group selector 120 selects the one of context groups 119A-K to which the next bin is assigned based on the context of the next bin. Context groups 119A-K may be defined in the same way as context groups 105A-K in entropy encoding unit 56A from FIG. 5A. For example, each of context groups 119A-K may be defined to include bins that represent the same types of syntax elements as context groups 105A-K. In some cases, the definitions of context groups 105A-K and 119A-K may be predetermined for both video encoder 20 and video decoder 30. In other cases, the definitions of context groups 119A-K may be signaled by video encoder 20 to video decoder 30 at one of a CU level, a video slice level, a video frame level, or a video sequence level.

Bin subset selector 118 then selects the one of bin subsets 117A-L in which the next bin is grouped with bins from across one or more of context groups 119A-K based on determined formations of the bin subsets. Bin subsets 117A-L may be defined according to the same determined formations as bins subsets 107A-L in entropy encoding unit 56A from FIG. 5A. For example, the determined formations of the bin subsets define the same number of bin subsets 117A-L as bin subsets 107A-L, and the same number of bins from one or more of context groups 119A-K included in each of bin subsets 117A-L as in bin subsets 107A-L. In some cases, the definitions of bin subsets 107A-L and bin subsets 117A-L may be predetermined for both video encoder 20 and video decoder 30. In other cases, the definitions of bin subsets 117A-L may be signaled by video encoder 20 to video decoder 30 at one of a CU level, a video slice level, a video frame level, or a video sequence level.

Bin subset decoder 116 may then entropy decode the variable length codeword associated with the selected one of bin subsets 117A-L into bins, including the next bin, in the selected one of bin subsets 117A-L . Bin subset decoder 116 may fill the decoded bin values into the selected one of bin subsets 117A-L. The bins included in the selected one of bin subsets 117A-L may be buffered until individually requested for decoding into video data symbols. From the selected one of bin subsets 117A-L, context modeling unit 122 may retrieve the decoded bin value of the next bin and update the probability estimate associated with the context of the next bin based on the value of the next bin.

If any of the decoded bins represents a portion of a non-binary valued video data symbol, de-binarization unit 124 may then de-binarize or map one or more other decoded bins in the sequence of bins into the video data symbol. As an example, de-binarization unit 124 may map a particular sequence of decoded bins to a non-binary value of a syntax element. Entropy decoding unit 80A may skip the de-binarization step for bins that represent binary valued video data symbols. As an example, a bin may represent a syntax element having a value of either 0 or 1 such that an additional de-binarization step is unnecessary.

Context modeling unit 122 may next determine a context for a subsequent bin in the sequence of bins to be decoded into the video data symbols. If the subsequent bin is included in one of bin subsets 117A-L for which the variable length codeword has already been decoded by bin subset decoder 116, then context modeling unit 122 may retrieve the subsequent bin value from the buffer. Otherwise, bin subset decoder 116 next entropy decodes the variable length codeword associated with the selected one of bin subsets 117A-L into bins, including the subsequent bin, in the selected one of bin subsets 117A-L . Bin subset decoder 116 may fill the decoded bin values into the selected one of bin subsets 117A-L and buffer the other bins until individually requested for decoding into video data symbols.

In this way, bin subset decoder 116 entropy decodes the variable length codewords into bins in respective bin subsets 117A-L. For example, bin subset decoder 116 may decode a first variable length codeword into bins within first bin subset 117A, and may similarly decode a second variable length codeword into bins within second bin subset 117B through to an Lth variable length codeword into bins within Lth bin subset 117L, depending on a given decoding order. In other examples, entropy decoding unit 80A may include a plurality of bin subset decoders capable of respectively decoding variable length codewords into bins in each of bin subsets 117A-L in parallel. In may be possible if all data associated with each of the bin subsets is kept separate in the encoded bitstream, i.e., data across different bin subsets may not be interleaved.

Upon receiving a request for a bin encoded included in a received variable length codeword, bin subset decoder 116 may decode the received variable length codeword into bins in the respective one of bin subsets 117A-L according to one of the VLC tables stored in VLC table store 113 for the bin subset. The VLC tables created in VLC table store 113 for each of bin subsets 117A-L may comprise the same VLC tables created in VLC table store 111 for each of bin subsets 107A-L in entropy encoding unit 56A from FIG. 5A.

In one example, bin subset decoder 116 may select a different VLC table from VLC table store 113 for each different combination of contexts of the bins included in each of bin subsets 107A-L. Bin subset decoder 116 may select the appropriate one of the VLC tables to decode a variable length codeword associated with bin subset 117A, for example, based on the contexts associated with each of the bins included in bin subset 117A. As described above, each of context groups 119A-K may include bins having one or more different contexts, e.g., 50 different contexts. In this case, the number of possible combinations of contexts of the bins in a given bin subset creates an undesirably large number of VLC tables to store for the bin subset.

In another example, probability group selector 114 may further select a probability group to which the requested bin in the selected one of context groups 119A-K is assigned based on a probability state of the requested bin associated with the context of the requested bin. Each of the probability groups has a representative probability associated with that probability group. In this case, bin subset decoder 1116 may select a different VLC table from VLC table store 113 for each different combination of representative probability states of the bins included in each of bin subsets 117A-L. Bin subset decoder 116 may select the appropriate one of the VLC tables to decode a variable length codeword associated with bin subset 117A, for example, based on the contexts associated with each of the bins included in bin subset 117A. In this case, assigning the bins to probability groups, may severely reduce a number of possible combinations of probabilities of the bins in a given bin subset and reduce a number of VLC tables to be stored for the bin subset.

One or more variable length codewords may be designed in each of the VLC tables created in VLC table store 113 for each of bin subsets 117A-L. The variable length codewords designed in each of the VLC tables stored in VLC table store 113 may comprise the same variable length codes designed for each of the VLC tables stored in VLC table store 111 in entropy encoding unit 56A from FIG. 5A. FIGS. 6A and 6B are block diagrams respectively illustrating an example entropy encoding unit 56B and an example entropy decoding unit 80B configured to entropy code bins from across probability groups.

In FIG. 6A, entropy encoding unit 56B comprises another example of entropy encoding unit 56 included in video encoder 20 from FIG. 2. Entropy encoding unit 56B includes a binarization unit 126, a context modeling unit 128, a probability group selector 130, a bin subset selector 132, a bin subset encoder 134, and a VLC table store 135. In the illustrated example of FIG. 6A, the techniques of this disclosure are directed toward performing entropy encoding of bins grouped into one or more bin subsets 133A-L from across one or more of a plurality of probability groups 131A-K using variable length codewords.

Entropy encoding unit 56B within video encoder 20 receives video data symbols, such as quantized transform coefficients and syntax elements, for a coding unit (CU) to be entropy encoded for storage or transmission to video decoder 30. Binarization unit 126 may binarize or map video data symbols that are not already binary valued into bins in a sequence of bins. As an example, binarization unit 126 may map a value of a syntax element that is not binary valued to a particular sequence of bins, where each bin has a value of 0 or 1. The location of each bin, e.g., first, second, etc., in the sequence of bins representing the syntax element may be referred to as its bin number. Entropy encoding unit 56B may skip the binarization step for video data symbols that are already binary valued. As an example, a syntax element may already have a value of either 0 or 1 such that an additional binarization step is unnecessary.

Context modeling unit 128 receives a sequence of bins that includes bins representing one or more of the coefficients and the syntax element for the CU to be encoded, including motion vector differences (MVDs), the split of the LCU into CUs, and the transform quadtree. Context modeling unit 128 selects contexts for each of the bins in the sequence of bins. The contexts for each bin may be selected based on at least one of a symbol category associated with the bin, a number of the bin within the sequence of bins, and values of previously coded bins. A context model specifies how to calculate the context of the bin to determine a probability estimate for a value (e.g., 0 or 1) of the bin. Let context(i) denote the context for bin number i, where i=0, 1, 2, . . . , N. Each different context index is associated with one of a plurality of probability estimates maintained by context modeling unit 128.

In addition, context modeling unit 128 determines a probability state for each of the bins that represents the probability estimate for the bin. The probability estimate may be based on a table-driven estimator using a finite-state machine (FSM). For each context, the FSM maintains an associated probability estimate by tracking past context values and providing a current probability state as the best probability estimate for the value of a given bin. For example, if the probability states range from 0 to 128, a state 0 may mean that the probability of the bin having a value of 0 is 0.9999, and a state 128 may mean that the probability of the bin having a value of 0 is 0.0001. Context modeling unit 128 updates the probability estimate associated with the context of the bin based on the actual value of the bin by transitioning to a different probability state. For example, if the actual value of a given bin is 0, then the probability that a value of a bin associated with the same context is equal to 0 may be increased by transitioning to a lower state.

Probability group selector 130 assigns each of the bins to a selected one of probability groups 131A-K based on the probability state of the bin. Probability groups 131A-K may be defined according to different intervals such that bins in each of probability groups 131A-K have probability states within the interval associated with the probability group. The intervals associated with probability groups 131A-K may be determined by dividing a range of all possible probability states into discrete ranges of probability states. For example, a range of possible probability states from 0 to 128 may be divided into twelve discrete intervals of probability states, each associated with one of probability groups 131A-K. Each of probability groups 131A-K may, therefore, have a representative probability associated with that probability group. In this way, video encoder 20 may only need to keep track of a representative probability state of each bin, and not the actual context assigned to the bin.

Bin subset selector 132 groups bins from across one or more of probability groups 131A-K into a selected one of bin subsets 133A-L based on determined formations of the bin subsets. The determined formations of the bin subsets define a number of bin subsets 133A-L and a number of bins from one or more of probability groups 131A-K included in each of bin subsets 133A-L. The determined formations of the bin subsets may be determined based on frequency of bin occurrence in each of probability groups 131A-K and overall efficiency of variable length codewords designed for each of the bin subsets. In this way, bin subsets 133A-L may be defined so as to be filled with the appropriate types of bins to form variable length codewords in the most efficient manner. The determined formations of the bin subsets may be pre-determined based on simulations using a plurality of video sequences and fixed for both a video encoder and a video decoder.

As one example, the determined formations of the bin subsets may define a first bin subset 133A for all the first bins in each of probability groups 131A-131K. As illustrated in FIG. 3A, the determined formations of the bin subsets may define a first bin subset 133A for all the first bins in a first portion of probability groups 131A-K that comprises less than all of the probability groups, and a second bin subset 133B for all the first bins in a second portion of probability groups 131A-K.

In a further example, as illustrated in FIG. 3B, the determined formations of the bin subsets may define a first bin subset 133A for one or more bins in a first probability group 131A and one or more bins in a second probability group 131B. In this case, first bin subset 133A may be defined for a first bin and a second bin in first probability group 131A, and a first bin in second probability group 131B. In an additional example, the determined formations of the bins subsets may define a first bin subset 133A for one or more bins of a first probability group 131A. In this case, first bin subset 133A may be defined for a first bin, a second bin, and a third bin in first probability group 131A, and not include any bins from other probability groups 131B-K. In other examples, more or fewer bin subsets 133A-L may be defined to include one or more bin from across one or more of probability groups 131A-K.

Bin subset encoder 134 entropy encodes the bins in respective bin subsets 133A-L into variable length codewords. For example, once the types of bins determined for first bin subset 133A are received by bin subset encoder 134, bin subset encoder 134 encodes the bins within first bin subset 133A into a variable length codeword. Bin subset encoder 134 may similarly encode bins within second bin subset 133B, through to bins within Lth bin subset 133L, depending on a given encoding order. In other examples, entropy encoding unit 56B may include a plurality of bin subset encoders capable of respectively encoding bins in each of bin subsets 133A-L in parallel. In may be possible if all data associated with each of the bin subsets is kept separate in the encoded bitstream, i.e., data across different bin subsets may not be interleaved.

Bin subset encoder 134 may select a different VLC table from VLC table store 135 for each of bin subsets 133A-L. As described above, each of probability groups 131A-K has a representative probability state. One or more variable length codewords may be designed in the VLC table created in VLC table store 135 for each of bin subsets 133A-L based on the representative probability state of each of the bins included in the bin subset. If one of bin subsets 133A-L is defined to include N different types of bins, there are 2^{N} potential input values of the N bins in the bin subset. For example, when bin subset 133A includes 3 different types of bins, there are 8 potential input values 000, 001, 010, 011, 100, 101, 110, and 111 in bin subset 133A. A different variable length codeword may be designed for each of the potential input values of the bins in each of bin subsets 133A-L. In addition, the variable length codewords may be designed based on probability estimates for the potential input values. For example, the most probable one of the potential input values in bin subset 133A may be encoded using the shortest variable length codeword, and the least probable one of the potential input values in bin subset 133A may be encoded using the longest variable length codeword. The variable length codewords designed for each of bin subsets 133A-L may be stored in VLC tables for the respective one of bin subsets 133A-L. The variable length codewords designed for each of bin subsets 133A-L may be pre-designed or may be adaptively designed for each CU, video slice, video frame, or video sequence.

The variable length codewords may be transmitted to video decoder 30 in a predetermined order. For example, video decoder 30 may expect to receive the codeword for first bin subset 133A first, followed by the codeword for second bin subset 133B second, and so on until the codeword for the Lth bin subset 133L. In order to send the variable length codewords in the predetermined order, bin subset encoder 134 may have to perform bin and codeword buffering. For example, while waiting to receive all the bins within first bin subset 133A, bin subset encoder 134 may buffer any received bins within bin subsets 133B-L and any completed variable length codewords for bin subsets 133B-L.

According to the techniques of this disclosure, the types of bins included in each of bin subsets 133A-L may be determined based on frequency of bin occurrence in each of probability groups 131A-K. Bin subsets 133A-L may also be defined so as to be filled with the appropriate types of bins to form variable length codewords in the most efficient manner. Bin subset encoder 134 has to wait to receive at least one bin of each type included in bin subset 133A to form a valid variable length codeword. If the frequency of occurrence of different bins included in bin subset 133A varies a great deal, a large amount of buffering may be needed by bin subset encoder 134 before all of the bins included in bin subset 133A are available for encoding. The techniques may reduce the amount of buffering by including bins from probability groups 131A-K that occur with similar frequency in bin subsets 133A-L. In addition, the techniques may further reduce the amount of buffering by including multiple bins from probability groups 131A-K that occur more frequently in bin subsets 133A-L. In this way, bins and completed codewords for bin subsets 133B-L only require a minimal amount of buffering in bin subset encoder 134 while waiting for a first valid codeword to be constructed for first bin subset 133A. The techniques, therefore, reduce an amount of bin and codeword buffering performed by bin subset encoder 134.

In FIG. 6B, entropy decoding unit 80B comprises one example of entropy decoding unit 80 included in video decoder 30 from FIG. 4. Entropy decoding unit 80B includes a bin subset decoder 138, a bin subset selector 140, a probability group selector 142, a context modeling unit 144, and a de-binarization unit 146. Entropy decoding unit 80B also includes VLC table store 137. In the illustrated example of FIG. 6B, the techniques of this disclosure are directed toward performing entropy decoding of variable length codewords into bins grouped into one or more bin subsets 139A-L from across one or more of a plurality of probability groups 141A-K.

Entropy decoding unit 80B within video decoder 30 receives an encoded bitstream of variable length codewords from video encoder 20. Video decoder 30 may receive the variable length codewords from video encoder 20 in a predetermined order. For example, video decoder 30 may expect to receive a codeword for first bin subset 139A first, followed by the codeword for second bin subset 139B second, and so on until the codeword for the Lth bin subset 139L.

In order to decode the variable length codewords into bins in each of bin subsets 139A-L, context modeling unit 144 first determines a probability state associated with a context for a next bin in the sequence of bins to be decoded into the video data symbols. For example, context modeling unit 144 may receive a request for the next bin, and determine a probability state associated with a context for the next bin based on the bin request. In some cases, binarization unit 146 may first binarize the bin request. Context modeling unit 144 may determine a probability state for the next bin, and each additional requested bin in the sequence of bins to be decoded, in substantially the same way as context modeling unit 128 in entropy encoding unit 56B from FIG. 6A. For example, the probability state for the next bin may represent a probability estimate for a value (e.g., 0 or 1) of the next bin associated with the context of the next bin in a context model.

Probability group selector 142 selects the one of probability groups 141A-K to which the next bin is assigned based on the probability state of the next bin. Probability groups 141A-K may be defined in the same way as probability groups 131A-K in entropy encoding unit 56B from FIG. 6A. For example, each of probability groups 141A-K may be defined according to the same intervals of probability states as probability groups 131A-K. In some cases, the definitions of probability groups 131A-K and 141A-K may be predetermined for both video encoder 20 and video decoder 30. In other cases, the definitions of probability groups 131A-K may be signaled by video encoder 20 to video decoder 30 at one of a CU level, a video slice level, a video frame level, or a video sequence level. In this way, video decoder 30 may only need to keep track of a probability state of each bin, and not the actual context assigned to the bin.

Bin subset selector 140 then selects the one of bin subsets 139A-L in which the next bin is grouped with bins from across one or more of probability groups 141A-K based on determined formations of the bin subsets. Bin subsets 139A-L may be defined according to the same determined formations as bins subsets 133A-L in entropy encoding unit 56B from FIG. 6A. For example, the determined formations of the bin subsets define the same number of bin subsets 139A-L as bin subsets 133A-L, and the same number of bins from one or more of probability groups 111A-K included in each of bin subsets 139A-L as in bin subsets 133A-L. In some cases, the definitions of bin subsets 133A-L and bin subsets 139A-L may be predetermined for both video encoder 20 and video decoder 30. In other cases, the definitions of bin subsets 139A-L may be signaled by video encoder 20 to video decoder 30 at one of a CU level, a video slice level, a video frame level, or a video sequence level.

Bin subset decoder 138 may then entropy decode the variable length codeword associated with the selected one of bin subsets 139A-L into bins, including the next bin, in the selected one of bin subsets 139A-L . Bin subset decoder 138 may fill the decoded bin value into the selected one of bin subsets 139A-L. The other bins included in the selected one of bin subsets 139A-L may be buffered until individually requested for decoding into video data symbols. From the selected one of bin subsets 139A-L, context modeling unit 144 may retrieve the decoded bin value of the next bin and update the probability estimate associated with the context of the next bin based on the value of the next bin.

If any of the decoded bins represents a portion of a non-binary valued video data symbol, de-binarization unit 146 may then de-binarize or map one or more decoded bins in the sequence of bins into the video data symbol. As an example, de-binarization unit 146 may map a particular sequence of decoded bins to a non-binary value of a syntax element. Entropy decoding unit 80B may skip the de-binarization step for bins that represent binary valued video data symbols. As an example, a bin may represent a syntax element having a value of either 0 or 1 such that an additional de-binarization step is unnecessary.

Context modeling unit 144 may next determine a probability state associated with a context for a subsequent bin in the sequence of bins to be decoded into the video data symbols. If the subsequent bin is included in one of bin subsets 139A-L for which the variable length codeword has already been decoded by bin subset decoder 138, then context modeling unit 144 may retrieve the subsequent bin value from the buffer. Otherwise, bin subset decoder 138 next entropy decodes the variable length codeword associated with the selected one of bin subsets 139A-L into bins, including the subsequent bin, in the selected one of bin subsets 139A-L . Bin subset decoder 138 may then fill the decoded bin values into the selected one of bin subsets 139A-L and buffer the other bins until individually requested for decoding into video data symbols.

In this way, bin subset decoder 138 entropy decodes the variable length codewords into bins in respective bin subsets 139A-L. For example, bin subset decoder 138 may decode a first variable length codeword into bins within first bin subset 139A, and may similarly decode a second variable length codeword into bins within second bin subset 139B through to an Lth variable length codeword into bins within Lth bin subset 139L, depending on a given decoding order. In other examples, entropy decoding unit 80B may include a plurality of bin subset decoders capable of respectively decoding variable length codewords into bins in each of bin subsets 139A-L in parallel. In may be possible if all data associated with each of the bin subsets is kept separate in the encoded bitstream, i.e., data across different bin subsets may not be interleaved.

Upon receiving a request for a bin included in a received variable length codeword, bin subset decoder 138 may decode the received variable length codeword into bins in the respective one of bin subsets 139A-L according to one the VLC table stored in VLC table store 137 for the bin subset. The VLC table created in VLC table store 137 for each of bin subsets 139A-L may comprise the same VLC table created in VLC table store 135 for each of bin subsets 133A-L in entropy encoding unit 56B from FIG. 6A. Bin subset decoder 138 may select a different VLC table from VLC table store 137 for each of bin subsets 139A-L. As described above, each of probability groups 141A-K has a representative probability state. Bin subset decoder 138 may select the VLC table created for bin subset 139A, for example, to decode a variable length codeword associated with bin subset 139A.

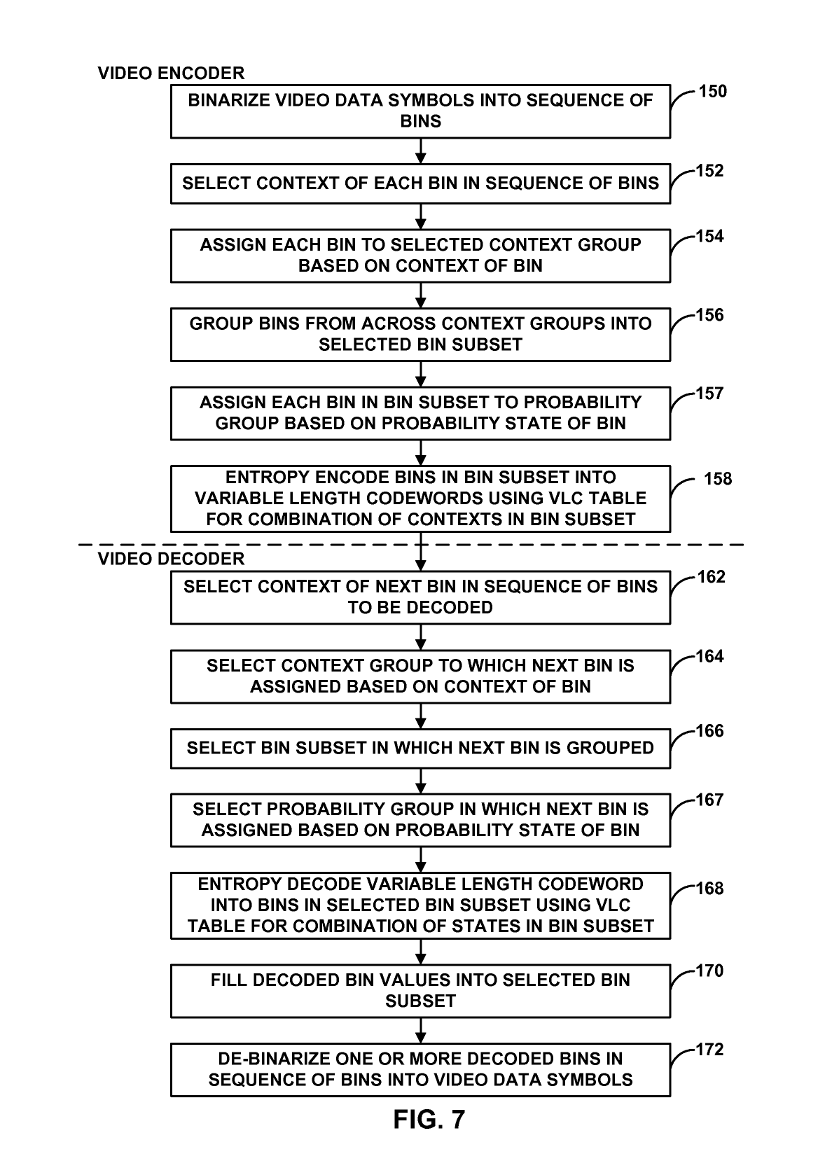

FIG. 7 is a flowchart illustrating an example operation of entropy encoding and decoding bins grouped into bin subsets from across context groups using variable length codewords. The example operation will be described with respect to entropy encoding unit 56A from FIG. 5A and entropy decoding unit 80A from FIG. 5B.

In video encoder 20, entropy encoding unit 56A receives video data symbols, such as quantized transform coefficients and syntax elements, to be entropy encoded for storage or transmission to video decoder 30. Binarization unit 100 may binarize or map video data symbols that are not already binary valued into bins in a sequence of bins (150). Entropy encoding unit 56A may skip the binarization step for video data symbols that are already binary valued. Context modeling unit 102 selects contexts for each of the bins in a sequence of bins (152). The contexts for each bin may be selected based on at least one of a symbol category associated with the bin, a number of the bin within the sequence of bins, and values of previously coded bins. A context model specifies how to select the context to determine a probability estimate for a value of the bin. Context modeling unit 102 updates the probability estimate associated with the context of the bin based on the value of the bin.

Context group selector 104 assigns each of the bins to a selected one of context groups 105A-K based on the context of the bin (154). Context groups 105A-K may be defined such that there are no context dependencies between bins in each of context groups 105A-K. In some examples, context group selector 104 may assign each of the bins based on a type of syntax element with which the bin is associated.

Bin subset selector 106 next groups bins from across one or more of context groups 105A-K into a selected one of bin subsets 107A-L based on determined formations of the bin subsets (156). The determined formations of the bin subsets define a number of bin subsets 107A-L and one bin from one or more of context groups 105A-K included in each of bin subsets 107A-L. The determined formations of the bin subsets may be determined based on frequency of bin occurrence in each of context groups 105A-K and overall efficiency of variable length codewords designed for each of the bin subsets. The determined formations of the bin subsets may be pre-determined based on simulations using a plurality of video sequences and fixed for both a video encoder and a video decoder.

Probability group selector 110 may then assign each of the bins in each of bin subsets 107A-L to a probability group based on a probability state associated with the context of the bin (157). Each of the probability groups may be defined according to a different interval that includes a discrete range of probability states from the range of all possible probability states. In this case, each of the probability groups has a representative probability associated with that probability group.

Bin subset encoder 108 then entropy encodes the bins in respective bin subsets 107A-L into variable length codewords using a VLC table for a combination of contexts of the bins included in the bin subset (158). For example, bin subset encoder 108 may select a different VLC table from VLC table store 111 for each different combination of representative probability states of the bins included in each of bin subsets 107A-L. Once the types of bins determined for first bin subset 107A, for example, are received by bin subset encoder 108, bin subset encoder 108 encodes the bins within first bin subset 107A into one of the variable length codewords designed in the selected one of the VLC tables for first bin subset 107A. Bin subset encoder 108 may similarly encode bins within second bin subset 107B through to Lth bin subset 107L using different VLC tables selected for each of the bin subsets 107B-L.

The variable length codewords may then be transmitted to video decoder 30 in a predetermined order. For example, video decoder 30 may expect to receive the codeword for first bin subset 107A first, followed by the codeword for second bin subset 107B second, and so on until the codeword for Lth bin subset 107L. In order to send the variable length codewords in the predetermined order, bin subset encoder 108 may have to perform bin and codeword buffering. For example, while waiting to receive all the bins within first bin subset 107A, bin subset encoder 108 may buffer any received bins within bin subsets 107B-L and any completed variable length codewords for bin subsets 107B-L. According to the techniques of this disclosure, the types of bins included in each of bin subsets 107A-L may be determined based on frequency of bin occurrence in each of context groups 105A-K. Bin subsets 107A-L may also be defined so as to be filled with the appropriate types of bins to form variable length codewords in the most efficient manner. The techniques, therefore, reduce an amount of bin and codeword buffering performed by bin subset encoder 108.

In video decoder 30, entropy decoding unit 80A receives an encoded bitstream of variable length codewords from video encoder 20. In order to decode the variable length codewords into bins in each of bin subsets 117A-L context modeling unit 122 selects a context for a next bin in the sequence of bins to be decoded into the video data symbols (162). For example, context modeling unit 122 may receive a request for the next bin, and determine the context for the next bin based on the bin request. The context for the next bin may be determined as described above with respect to context modeling unit 102 in entropy encoding unit 56A.

Context group selector 120 selects the one of context groups 119A-K to which the next bin is assigned based on the context of the next bin (164). Bin subset selector 118 then selects the one of bin subsets 117A-L in which the next bin is grouped with bins from across one or more of context groups 119A-K based on determined formations of the bin subsets (166). Context groups 119A-K may be defined in the same way as context groups 105A-K in entropy encoding unit 56. Moreover, bin subsets 117A-L may be defined according to the same determined formations as bins subsets 107A-L in entropy encoding unit 56A. Probability group selector 114 may then select the probability group to which the next bin is assigned based on a probability state associated with the context of the next bin (167). Each of the probability groups may be defined according to a different interval that includes a discrete range of probability states from the range of all possible probability states. In this case, each of the probability groups has a representative probability associated with that probability group.

Bin subset decoder 116 then entropy decodes a variable length codeword associated with the selected one of bin subsets 117A-L into bins, including the next bin, in the selected one of bin subsets 117A-L using a VLC table for a combination of contexts of the bins included in the bin subset (168). For example, bin subset decoder 116 may select a different VLC table from VLC table store 113 for each different combination of representative probability states of the bins included in each of bin subsets 117A-L. Upon receiving a request for a bin encoded included in a received variable length codeword, bin subset decoder 116 may decode the received variable length codeword into bins in bin subset 117A, for example, according to the selected one of the VLC tables for bin subset 117A.

Bin subset decoder 116 may then fill the decoded bin values into the selected one of bin subsets 117A-L (170). The bins included in the selected one of bin subsets 117A-L may be buffered until individually requested for decoding into video data symbols. Context modeling unit 122 may retrieve the decoded bin value of the next bin and update the probability estimate associated with the context of the next bin based on the value of the next bin. If any of the decoded bins represents a portion of a non-binary valued video data symbol, de-binarization unit 124 may then de-binarize or map one or more decoded bins in the sequence of bins into the video data symbol (172).

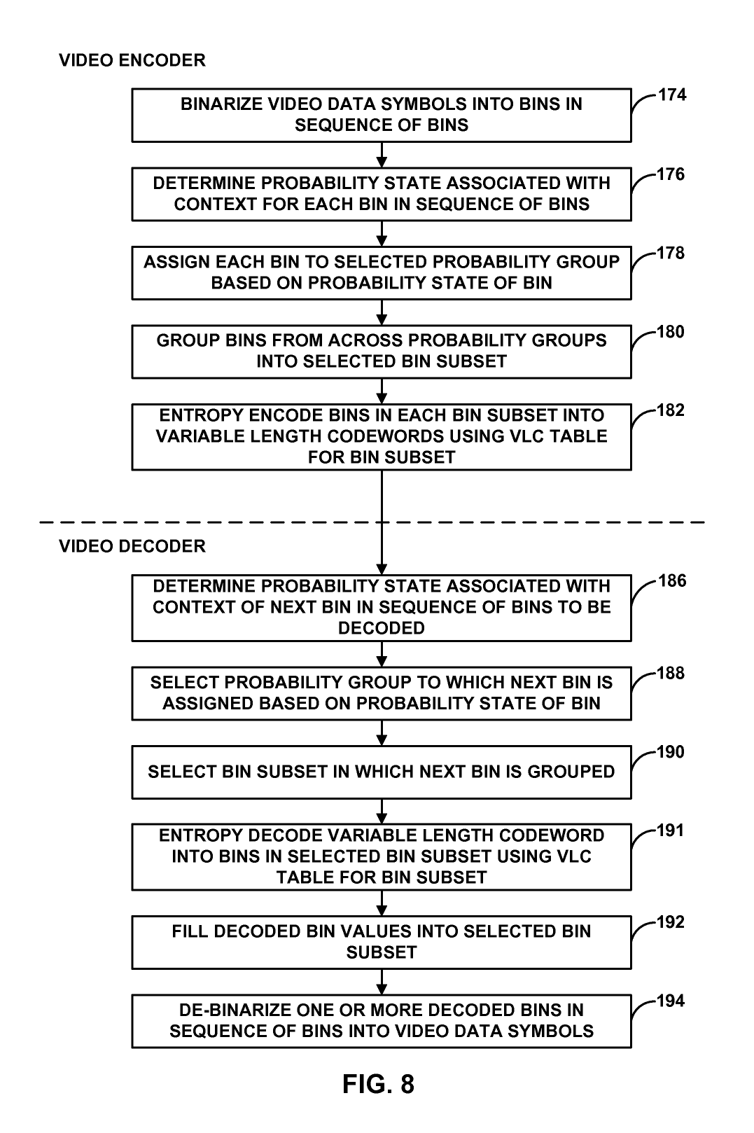

FIG. 8 is a flowchart illustrating an example operation of entropy encoding and decoding bins grouped into bin subsets from across probability groups using variable length codewords. The example operation will be described with respect to entropy encoding unit 56B from FIG. 6A and entropy decoding unit 80B from FIG. 6B.

In video encoder 20, entropy encoding unit 56B receives video data symbols, such as quantized transform coefficients and syntax elements, to be entropy encoded for storage or transmission to video decoder 30. Binarization unit 100 may binarize or map video data symbols that are not already binary valued into bins in a sequence of bins (174). Entropy encoding unit 56A may skip the binarization step for video data symbols that are already binary valued. Context modeling unit 128 determines probability states associated with contexts for each of the bins in the sequence of bins (176). The contexts for each bin may be selected based on at least one of a symbol category associated with the bin, a number of the bin within the sequence of bins, and values of previously coded bins. A context model specifies how to select the context to determine a probability estimate for a value of the bin. The probability estimate for each of the bins may be represented by a probability state. Context modeling unit 128 updates the probability estimate associated with the context of the bin based on the value of the bin by transitioning to a different probability state.

Probability group selector 130 assigns each of the bins to a selected one of probability groups 131A-K based on the probability state of the bin (178). Probability groups 131A-K may be defined according to different intervals such that bins in each of probability groups 131A-K have probability states within the interval associated with the probability group. The intervals associated with probability groups 131A-K may be determined by dividing a range of all possible probability states into discrete ranges of probability states. Each of the probability groups has a representative probability associated with that probability group. In this way, video encoder 20 may only need to keep track of a representative probability state of each bin, and not the actual context assigned to the bin.

Bin subset selector 132 next groups bins from across one or more of probability groups 131A-K into a selected one of bin subsets 133A-L based on determined formations of the bin subsets (180). The determined formations of the bin subsets define a number of bin subsets 133A-L and a number of bins from one or more probability groups 131A-K included in each of bin subsets 133A-L. The determined formations of the bin subsets may be determined based on frequency of bin occurrence in each of probability groups 131A-K and overall efficiency of variable length codewords designed for each of the bin subsets. The determined formations of the bin subsets may be pre-determined based on simulations using a plurality of video sequences and fixed for both a video encoder and a video decoder.

Bin subset encoder 134 then entropy encodes the bins in respective bin subsets 133A-L into variable length codewords using a VLC table for the bin subset (182). For example, bin subset encoder 134 may select a different VLC table from VLC table store 135 for each of bin subsets 133A-L. Once the types of bins determined for first bin subset 133A are received by bin subset encoder 134, bin subset encoder 134 encodes the bins within first bin subset 133A into one of the variable length codewords designed for the VLC table for first bin subset 133A. Bin subset encoder 134 may similarly encode bins within second bin subset 133B through to Lth bin subset 133L using different VLC tables for each of bin subsets 133B-L.

The variable length codewords may then be transmitted to video decoder 30 in a predetermined order. For example, video decoder 30 may expect to receive the codeword for first bin subset 133A first, followed by the codeword for second bin subset 133B second, and so on until the codeword for Lth bin subset 133L. In order to send the variable length codewords in the predetermined order, bin subset encoder 134 may have to perform bin and codeword buffering. For example, while waiting to receive all the bins within first bin subset 133A, bin subset encoder 134 may buffer any received bins within bin subsets 133B-L and any completed variable length codewords for bin subsets 133B-L. According to the techniques of this disclosure, the types of bins included in each of bin subsets 133A-L may be determined based on frequency of bin occurrence in each of probability groups 131A-K. Bin subsets 133A-L may also be defined so as to be filled with the appropriate types of bins to form variable length codewords in the most efficient manner. The techniques, therefore, reduce an amount of bin and codeword buffering performed by bin subset encoder 134.

In video decoder 30, entropy decoding unit 80B receives an encoded bitstream of variable length codewords from video encoder 20. In order to decode the variable length codewords into bins in each of bin subsets 139A-L context modeling unit 144 determines a probability state associated with a context for a next bin in the sequence of bins to be decoded into the video data symbols (186). For example, context modeling unit 144 may receive a request for the next bin, and determine the context for the next bin based on the bin request. The context for the next bin may be determined as described above with respect to context modeling unit 128 in entropy encoding unit 56B.

Probability group selector 142 selects the one of probability groups 141A-K to which the next bin is assigned based on the probability state of the next bin (188). Bin subset selector 140 then selects the one of bin subsets 139A-L in which the next bin is grouped with bins from across one or more of probability groups 141A-K based on determined formations of the bin subsets (190). Probability groups 141A-K may be defined in the same way as probability groups 131A-K in entropy encoding unit 56B. Moreover, bin subsets 139A-L may be defined according to the same determined formations as bins subsets 133A-L in entropy encoding unit 56B.

Bin subset decoder 138 then entropy decodes a variable length codeword associated with the selected one of bin subsets 139A-L into bins, including the next bin, in the selected one of bin subsets 139A-L using a VLC table for the bin subset (191). For example, bin subset decoder 138 may select a different VLC table from VLC table store 137 for each of bin subsets 139A-L. Upon receiving a request for a bin encoded included in a received variable length codeword, bin subset decoder 138 may decode the received variable length codeword into bins in bin subset 139A, for example, according to the VLC table for bin subset 139A.

Bin subset decoder 138 may then fill the decoded bin values into the selected one of bin subsets 139A-L (192). The bins included in the selected one of bin subsets 139A-L may be buffered until individually requested for decoding into video data symbols. Context modeling unit 144 may retrieve the decoded bin value of the next bin from the selected one of probability groups 141A-K and update the probability estimate associated with the context of the next bin based on the value of the next bin. If any of the decoded bins represents a portion of a non-binary valued video data symbol, de-binarization unit 146 may then de-binarize or map one or more decoded bins in the sequence of bins into the video data symbol (194).

In one or more examples, the functions described may be implemented in hardware, software, firmware, or any combination thereof If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

1. A method for coding video data comprising:
selecting a context for each bin in a sequence of bins representing video data symbols;
selecting one of a plurality of context groups for each of the bins based on the context of the bin, wherein bins in one of the context groups do not have context dependencies with bins in another of the context groups;
selecting one of one or more bin subsets for each of the bins based on determined formations of the bin subsets, wherein each of the bin subsets includes bins from across one or more of the context groups; and
entropy coding the bins in each of the bin subsets using variable length codewords.

2. The method of claim 1, wherein selecting one of a plurality of context groups for each of the bins comprises selecting one of the context groups for a bin based on a type of syntax element associated with the bin.

3. The method of claim 1, wherein the determined formations of the bin subsets define a number of bin subsets and one bin from one or more of the context groups included in each of the bin subsets based on frequency of bin occurrence in each of the context groups and efficiency of the variable length codewords for each of the bin subsets.

4. The method of claim 1, wherein each of the context groups includes bins having one or more contexts, further comprising selecting a different table of variable length codewords for each different combination of contexts of the bins included in each of the bin subsets, wherein one or more variable length codewords are designed in each of the tables based on the contexts of the bins.

5. The method of claim 1, further comprising selecting one of a plurality of probability groups for each of the bins included in each of the bin subsets based on a probability state associated with the context of the bin, wherein bins in each of the probability groups have probability states within an interval associated with the probability group.

6. The method of claim 5, wherein each of the probability groups has a representative probability state, further comprising selecting a different table of variable length codewords for each different combination of representative probability states of the bins included in each of the bin subsets, wherein one or more variable length codewords are designed in each of the tables based on the contexts of the bins.

7. The method of claim 1, wherein the method comprises a method of decoding video data,
wherein selecting a context for each bin comprises selecting a context for a next bin in the sequence of bins to be decoded into the video data symbols;
wherein selecting one of a plurality of context groups for each of the bins comprises selecting the one of the context groups to which the next bin is assigned based on the context of the next bin;
wherein selecting one of one or more bin subsets for each of the bins comprises selecting the one of the bin subsets in which the next bin is grouped with bins from across the context groups based on the determined formations of the bin subsets; and
wherein entropy coding comprises entropy decoding the one of the variable length codewords associated with the selected one of the bin subsets into bins in the selected one of the bin subsets, wherein the bins include the next bin.

8. The method of claim 7, further comprising de-binarizing one or more of the decoded bins in the sequence of bins into one or more of the video data symbols.

9. The method of claim 1, wherein the method comprises a method of encoding video data comprising:
assigning each of the bins to the selected one of the context groups based on the context of the bin; and
grouping bins from across the context groups into the selected one of the bin subsets based on the determined formations of the bin subsets,
wherein entropy coding comprises entropy encoding the bins in each of the bin subsets into the variable length codewords.

10. The method of claim 9, further comprising binarizing one or more of the video data symbols into one or more bins in the sequence of bins.

11. The method of claim 1, wherein selecting one of one or more bin subsets for each of the bins comprises selecting a first bin subset for first bins from one or more of the context groups.

12. The method of claim 1, further comprising, when a variable length codeword is not formed for a period of time, entropy coding the bins in each of the context groups using variable-to-variable length (V2V) codewords.

13. The method of claim 12, further comprising coding a syntax element indicating when to switch from entropy coding the bins in each of the bin subsets using variable length codewords to entropy coding the bins in each of the context groups using V2V codewords.

14. The method of claim 1, wherein entropy coding comprises entropy coding the bins in each of the bin subsets using the variable length codewords in parallel.

15. A video coding device comprising:
a memory that stores video data symbols; and
a processor configured to select a context for each bin in a sequence of bins representing video data symbols, select one of a plurality of context groups for each of the bins based on the context of the bin, wherein bins in one of the context groups do not have context dependencies with bins in another of the context groups, select one of one or more bin subsets for each of the bins based on determined formations of the bin subsets, wherein each of the bin subsets includes bins from across one or more of the context groups, and entropy code the bins in each of the bin subsets using variable length codewords.

16. The video coding device of claim 15, wherein the processor selects one of the context groups for a bin based on a type of syntax element associated with the bin.

17. The video coding device of claim 15, wherein the determined formations of the bin subsets define a number of bin subsets and one bin from one or more of the context groups included in each of the bin subsets based on frequency of bin occurrence in each of the context groups and efficiency of the variable length codewords for each of the bin subsets.

18. The video coding device of claim 15, wherein each of the context groups includes bins having one or more contexts, wherein the processor selects a different table of variable length codewords for each different combination of contexts of the bins included in each of the bin subsets, and wherein one or more variable length codewords are designed in each of the tables based on the contexts of the bins.

19. The video coding device of claim 15, wherein the processor selects one of a plurality of probability groups for each of the bins included in each of the bin subsets based on a probability state associated with the context of the bin, wherein bins in each of the probability groups have probability states within an interval associated with the probability group.

20. The video coding device of claim 19, wherein each of the probability groups has a representative probability state, wherein the processor selects a different table of variable length codewords for each different combination of representative probability states of the bins included in each of the bin subsets, and wherein one or more variable length codewords are designed in each of the tables based on the contexts of the bins.

21. The video coding device of claim 15, wherein the video coding device comprises a video decoding device, and wherein the processor selects a context for a next bin in the sequence of bins to be decoded into the video data symbols, selects the one of the context groups to which the next bin is assigned based on the context of the next bin, selects the one of the bin subsets in which the next bin is grouped with bins from across the context groups based on the determined formations of the bin subsets, and entropy decodes the one of the variable length codewords associated with the selected one of the bin subsets into bins in the selected one of the bin subsets, wherein the bins include the next bin.

22. The video coding device of claim 21, wherein the processor de-binarizes one or more of the decoded bins in the sequence of bins into one or more of the video data symbols.

23. The video coding device of claim 15, wherein the video coding device comprises a video encoding device, and wherein the processor assigns each of the bins to the selected one of the context groups based on the context of the bin, groups bins from across the context groups into the selected one of the bin subsets based on the determined formations of the bin subsets, and entropy encodes the bins in each of the bin subsets into the variable length codewords.

24. The video coding device of claim 23, wherein the processor binarizes one or more of the video data symbols into one or more bins in the sequence of bins.

25. The video coding device of claim 15, wherein the processor selects a first bin subset for first bins from one or more of the context groups.

26. The video coding device of claim 15, wherein, when a variable length codeword is not formed for a period of time, the processor entropy codes the bins in each of the context groups using variable-to-variable length (V2V) codewords.

27. The video coding device of claim 26, wherein the processor codes a syntax element indicating when to switch from entropy coding the bins in each of the bin subsets using variable length codewords to entropy coding the bins in each of the context groups using V2V codewords.

28. The video coding device of claim 15, wherein the processor entropy codes the bins in each of the bin subsets using the variable length codewords in parallel.

29. A video coding device comprising:
means for selecting a context for each bin in a sequence of bins representing video data symbols;
means for selecting one of a plurality of context groups for each of the bins based on the context of the bin, wherein bins in one of the context groups do not have context dependencies with bins in another of the context groups;
means for selecting one of one or more bin subsets for each of the bins based on determined formations of the bin subsets, wherein each of the bin subsets includes bins from across one or more of the context groups; and
means for entropy coding the bins in each of the bin subsets using variable length codewords.

30. A computer-readable medium comprising instructions for coding video data that, when executed, cause a processor to:
select a context for each bin in a sequence of bins representing video data symbols;
select one of a plurality of context groups for each of the bins based on the context of the bin, wherein bins in one of the context groups do not have context dependencies with bins in another of the context groups;
select one of one or more bin subsets for each of the bins based on determined formations of the bin subsets, wherein each of the bin subsets includes bins from across one or more of the context groups; and
entropy code the bins in each of the bin subsets using variable length codewords.

31. A method for coding video data comprising:
determining a probability state associated with a context for each bin in a sequence of bins representing video data symbols;
selecting one of a plurality of probability groups for each of the bins based on the probability state of the bin, wherein bins in each of the probability groups have probability states within an interval associated with the probability group;
selecting one of one or more bin subsets for each of the bins based on determined formations of the bin subsets, wherein each of the bin subsets includes bins from across one or more of the probability groups; and
entropy coding the bins in each of the bin subsets using variable length codewords.

32. The method of claim 31, wherein the intervals associated with the probability groups are determined by dividing a range of possible probability states into a plurality of discrete ranges of probability states.

33. The method of claim 31, wherein the determined formations of the bin subsets define a number of bin subsets and a number of bins from one or more of the probability groups included in each of the bin subsets based on frequency of bin occurrence in each of the probability groups and efficiency of the variable length codewords for each of the bin subsets.

34. The method of claim 1, wherein each of the probability groups has a representative probability state, and wherein one or more variable length codewords are designed for each of the bin subsets based on the representative probability state of each of the bins included in the bin subset.

35. The method of claim 1, wherein the method comprises a method of decoding video data,
wherein determining a probability state comprises determining a probability state associated with a context for a next bin in the sequence of bins to be decoded into the video data symbols;
wherein selecting one of a plurality of probability groups for each of the bins comprises selecting the one of the probability groups to which the next bin is assigned based on a probability state associated with a context of the next bin;
wherein selecting one of one or more bin subsets for each of the bins comprises selecting the one of the bin subsets in which the next bin is grouped with bins from across the probability groups based on the determined formations of the bin subsets; and wherein entropy coding comprises entropy decoding the one of the variable length codewords associated with the selected one of the bin subsets into bins in the selected one of the bin subsets, wherein the bins include the next bin.

36. The method of claim 35, further comprising de-binarizing the next bin and one or more other decoded bins in the sequence of bins into one or more of the video data symbols.

37. The method of claim 31, wherein the method comprises a method of encoding video data further comprising:
assigning each of the bins to the selected one of the probability groups based on the probability state of the bin; and
grouping bins from across the probability groups into the selected one of the bin subsets based on the determined formations of the bin subsets,
wherein entropy coding comprises entropy encoding the bins in each of the bin subsets into the variable length codewords.

38. The method of claim 37, further comprising binarizing one or more of the video data symbols into one or more bins in the sequence of bins.

39. The method of claim 31, wherein selecting one of one or more bin subsets for each of the bins comprises selecting a first bin subset for first bins from one or more of the probability groups.

40. The method of claim 31, wherein selecting one of one or more bin subsets for each of the bins comprises selecting a first bin subset for one or more bins from one or more of the probability groups.

41. The method of claim 31, further comprising, when a variable length codeword is not formed for a period of time, entropy coding the bins in each of the probability groups using variable-to-variable length (V2V) codewords.

42. The method of claim 41, further comprising coding a syntax element indicating when to switch from entropy coding the bins in each of the bin subsets using variable length codewords to entropy coding the bins in each of the probability groups using V2V codewords.

43. The method of claim 31, wherein entropy coding comprises entropy coding the bins in each of the bin subsets using the variable length codewords in parallel.

44. A video coding device comprising:
a memory that stores video data symbols; and
a processor configured to determine a probability state associated with a context for each bin in a sequence of bins representing video data symbols, select one of a plurality of probability groups for each of the bins based on the probability state of the bin, wherein bins in each of the probability groups have probability states within an interval associated with the probability group, select one of one or more bin subsets for each of the bins based on determined formations of the bin subsets, wherein each of the bin subsets includes bins from across one or more of the probability groups, and entropy code the bins in each of the bin subsets using variable length codewords.

45. The video coding device of claim 44, wherein the intervals associated with the probability groups are determined by dividing a range of possible probability states into a plurality of discrete ranges of probability states.

46. The video coding device of claim 44, wherein the determined formations of the bin subsets define a number of bin subsets and a number of bins from one or more of the probability groups included in each of the bin subsets based on frequency of bin occurrence in each of the probability groups and efficiency of the variable length codewords for each of the bin subsets.

47. The video coding device of claim 44, wherein each of the probability groups has a representative probability state, and wherein one or more variable length codewords are designed for each of the bin subsets based on the representative probability state of each of the bins included in the bin subset.

48. The video coding device of claim 44, wherein the video coding device comprises a video decoding device,
wherein the processor determines a probability state associated with a context for a next bin in the sequence of bins to be decoded into the video data symbols, selects the one of the probability groups to which the next bin is assigned based on a probability state associated with a context of the next bin, selects the one of the bin subsets in which the next bin is grouped with bins from across the probability groups based on the determined formations of the bin subsets, and entropy decodes the one of the variable length codewords associated with the selected one of the bin subsets into bins in the selected one of the bin subsets, wherein the bins include the next bin.

49. The video coding device of claim 48, wherein the processor de-binarizes the next bin and one or more other decoded bins in the sequence of bins into one or more of the video data symbols.

50. The video coding device of claim 44, wherein the video coding device comprises a video encoding device, wherein the processor assigns each of the bins to the selected one of the probability groups based on the probability state of the bin, groups bins from across the probability groups into the selected one of the bin subsets based on the determined formations of the bin subsets, and entropy encodes the bins in each of the bin subsets into the variable length codewords.

51. The video coding device of claim 50, wherein the processor binarizes one or more of the video data symbols into one or more bins in the sequence of bins.

52. The video coding device of claim 44, wherein the processor selects a first bin subset for first bins from one or more of the probability groups.

53. The video coding device of claim 44, wherein the processor selects a first bin subset for one or more bins from one or more of the probability groups.

54. The video coding device of claim 44, wherein, when a variable length codeword is not formed for a period of time, the processor entropy codes the bins in each of the probability groups using variable-to-variable length (V2V) codewords.

55. The video coding device of claim 54, wherein the processor codes a syntax element indicating when to switch from entropy coding the bins in each of the bin subsets using variable length codewords to entropy coding the bins in each of the probability groups using V2V codewords.

56. The video coding device of claim 44, wherein the processor entropy codes the bins in each of the bin subsets using the variable length codewords in parallel.

57. A video coding device comprising:
means for determining a probability state associated with a context for each bin in a sequence of bins representing video data symbols;
means for selecting one of a plurality of probability groups for each of the bins based on the probability state of the bin, wherein bins in each of the probability groups have probability states within an interval associated with the probability group;
means for selecting one of one or more bin subsets for each of the bins based on determined formations of the bin subsets, wherein each of the bin subsets includes bins from across one or more of the probability groups; and
means for entropy coding the bins in each of the bin subsets using variable length codewords.

58. A computer-readable medium comprising instructions for coding video data that, when executed, cause a processor to:
determine a probability state associated with a context for each bin in a sequence of bins representing video data symbols;
select one of a plurality of probability groups for each of the bins based on the probability state of the bin, wherein bins in each of the probability groups have probability states within an interval associated with the probability group;
select one of one or more bin subsets for each of the bins based on determined formations of the bin subsets, wherein each of the bin subsets includes bins from across one or more of the probability groups; and
entropy code the bins in each of the bin subsets using variable length codewords.
